(19) United States
(12) Patent Application Publication
(10) Pub. No.: US 2026/0341200 A1
(43) Pub. Date: Oct. 29, 2026

(54) DISPLAY PIXEL AND DISPLAY DEVICE INCLUDING THEREOF

(71) Applicant: SAMSUNG ELECTRONICS CO., LTD., Suwon-si (KR)

(72) Inventors: SUNKWON KIM, Suwon-si (KR); Dongsoon JUNG, Suwon-si (KR); TAE-HYEON KWON, Suwon-si (KR); YONGIL KWON, Suwon-si (KR); KANG JOO KIM, Suwon-si (KR); HYUNWOOK LIM, Suwon-si (KR)

(73) Assignee: SAMSUNG ELECTRONICS CO., LTD., Suwon-si (KR)

(21) Appl. No.: 19/647,334

(22) Filed: Apr. 14, 2026

(30) Foreign Application Priority Data
Apr. 24, 2025 (KR) 10-2025-0054021
Sep. 1, 2025 (KR) 10-2025-0123160

(51) Int. Cl. G09G 3/32

(52) U.S. Cl. CPC G09G 3/32; G09G 2300/0814; G09G 2300/0842; G09G 2310/0267; G09G 2310/0275; G09G 2310/08

(57) ABSTRACT

A display device includes a column driver, a row driver and a first display pixel including an in-pixel memory. The column driver controls first and second data lines based on first pixel driving data including a plurality of pixel driving bits, and the row driver controls an operation of the first display pixel. The first display pixel writes one or more pixel driving bits among the plurality of pixel driving bits into the in-pixel memory during a first time period at which the first display pixel performs a first light emission operation for the first pixel driving data.

### CROSS-REFERENCE TO RELATED APPLICATION

This application is based on and claims priority to Korean Patent Application No. 10-2025-0054021 filed with the Korean Patent Office on Apr. 24, 2025, and Korean Patent Application No. 10-2025-0123160 filed with the Korean Patent Office on Sep. 01, 2025, the entire contents of which are incorporated herein by reference.

### BACKGROUND

### Field

The present disclosure relates to a semiconductor display. More specifically, the present disclosure relates to a display pixel and a display device including the same.

### Description of the Related Art

A luminance resolution of a display pixel that operates in pulse width modulation (PWM) scheme may be determined by a level (or a degree) of precision with which a duty ratio of the PWM signal used for light emission of the display pixel can be adjusted.

In general, the duty ratio of the PWM signal used for light emission of the display pixel may be determined based on a plurality of pixel driving bits stored in an in-pixel memory. Accordingly, to increase the luminance resolution of display pixels operating in PWM scheme, a larger capacity in-pixel memory may be required. Therefore, it may be technically difficult to achieve high luminance resolution with a small area of display pixels.

### SUMMARY

The present disclosure is intended to solve the above-described technical problems. More specifically, the present disclosure relates to a display pixel having a small area and operating with a high luminance resolution and a display device including the same.

According to an aspect of the disclosure, there is provided a display device including: a column driver configured to: receive a first pixel driving data comprising a plurality of pixel driving bits, and control a first data line and a second data line based on the first pixel driving data; a first display pixel comprising an in-pixel memory and connected to the first data line and the second data line; and a row driver configured to control an operation of the first display pixel, wherein the first display pixel is configured to write one or more pixel driving bits among the plurality of pixel driving bits into the in-pixel memory during a first time period during which the first display pixel performs a first light emission operation corresponding to the first pixel driving data.

According to another aspect of the disclosure, there is provided a display device including: a column driver configured to control one or more data lines based on a first pixel driving data, the first pixel driving data comprising discard data having a first code length and retention data having a second code length; a display pixel connected to one or more of the one or more data lines and comprising an in-pixel memory having a capacity corresponding to the second code length; and a row driver configured to control the display pixel to perform a first light emission operation based on the discard data during a first time period, and control the display pixel to perform a second light emission operation based on the retention data during a second time period after the first time period, wherein the in-pixel memory is configured to store the retention data during the second time period.

According to another aspect of the disclosure, there is provided a display pixel including: an in-pixel memory comprising a shift register and an independent bit cell; a source selection multiplexer configured to generate a pulse width modulation (PWM) signal based on a first output signal from the shift register and a second output signal from the independent bit cell; and a light emission circuit configured to perform a first light emission operation based on the PWM signal during a first time period at which the in-pixel memory performs a data writing operation.

### BRIEF DESCRIPTION OF DRAWINGS

FIG. 1 is a block diagram showing a display device according to an embodiment of the present disclosure.

FIG. 2 is a block diagram showing the configuration of the display pixels of FIG. 1 in more detail.

FIG. 3 is a timing diagram showing a driving method of a display pixel according to a comparative example.

FIG. 4 is a block diagram showing in more detail the configuration of the PWM control circuit of FIG. 2 according to an embodiment of the present disclosure.

FIG. 5 is a diagram showing the configuration of pixel driving data according to an embodiment of the present disclosure.

FIG. 6 is a circuit diagram showing a configuration of display pixel according to an embodiment of the present disclosure in more detail.

FIG. 7 is a drawing showing in more detail the configuration of a PWM signal according to an embodiment.

FIGS. 8-11 are timing diagrams showing in more detail the operation of a display device according to various embodiments of the present disclosure.

FIG. 12 is a diagram showing the effect in an example case in which the column driver is implemented to provide pixel driving bits read from external memory to the data line.

FIG. 13 is a timing diagram exemplarily showing a method of driving display pixels according to an embodiment.

FIG. 14 is a timing diagram showing a frame period according to an embodiment.

FIG. 15 is a timing diagram showing a frame period according to an embodiment.

FIG. 16 is a timing diagram showing a frame period according to an embodiment.

FIG. 17 is a diagram showing a state of the PWM signal during the prior light emission period of FIG. 16 according to an embodiment.

FIG. 18 is a block diagram showing a display device according to an embodiment of the present disclosure.

FIG. 19 is a drawing showing in more detail the configuration of a PWM signal according to the embodiment of FIG. 18.

FIG. 20 is a timing diagram showing a driving method of a display pixel according to the embodiment of FIG. 19.

### DETAILED DESCRIPTION

Hereinafter, embodiments of the present disclosure will be described clearly and in detail to such an extent that a person having ordinary skill in the art of the present disclosure may easily practice the present disclosure.

The components described below may be implemented as various types of software, such as firmware, applications, etc., or as various types of hardware, such as electrical circuits, electronic circuits, processors, etc. However, the scope of the present disclosure is not limited thereto, and the components described below may be implemented as a combination of software and hardware.

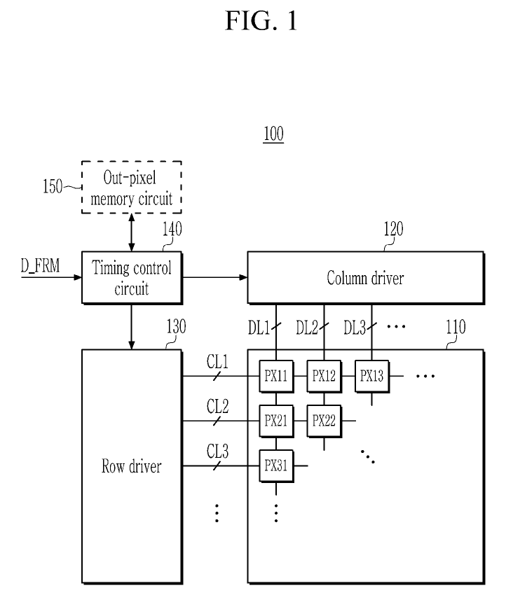

FIG. 1 is a block diagram showing a display device 100 according to an embodiment of the present disclosure. The display device 100 may include a display pixel array 110, a column driver 120, a row driver 130, and a timing control circuit 140. However, the disclosure is not limited thereto, and as such, according to an embodiment, the display device 100 may include one or more other components.

In an embodiment, the display device 100 may be included in various types of electronic devices such as a monitor, a screen, an augmented reality (AR) glass, a virtual reality (VR) headset, etc.

The display pixel array 110 may include a plurality of display pixels PX. The plurality of display pixels PX may be arranged in a matrix form along a row direction and a column direction. However, the scope of the present disclosure is not limited thereto, and the plurality of display pixels PX may be arranged in a zigzag pattern.

Each of the plurality of display pixels PX may be connected to one or more data lines DL and one or more control lines CL. For example, display pixels PX arranged in same display pixel row may share one or more control lines CL, and display pixels PX arranged in same display pixel column may share one or more data lines DL.

In an embodiment, a display pixel PX arranged in an i-th display pixel row and a j-th display pixel column of the display pixel array 110 may be referred to as “PXij”. The display pixel PXij may be connected to one or more i-th control lines CLi and may be connected to one or more j-th data lines DLj. For example, a display pixel PX12 may be connected to one or more first control lines CL1 and may be connected to one or more second data lines DL2.

The column driver 120 may control the plurality of data lines DL. For example, the column driver 120 may provide pixel driving data (hereinafter referred to as “PDD”) to the plurality of display pixel columns through the plurality of data lines DL. For example, the column driver 120 may provide different PDD to the plurality of display pixel columns.

The row driver 130 may control the plurality of control lines CL. For example, the row driver 130 may provide pixel control signals (hereinafter referred to as “CTRL”) to the plurality of display pixel rows through the plurality of control lines CL. For example, the row driver 130 may provide different CTRL to the plurality of display pixel rows.

The row driver 130 may control the plurality of display pixels PX in unit of display pixel rows. For example, the row driver 130 may control an operation of display pixels PX included in a display pixel row by controlling logic levels of pixel control signals CTRL provided to the display pixel row. According to an embodiment, the row driver 130 may control pixel control signals CTRL provided to one display pixel row to control display pixels PX included in the display pixel row to receive pixel driving data PDD from data line DL, or to control the display pixels PX included in the display pixel row to perform a light emission operation based on the pixel driving data PDD.

The timing control circuit 140 may receive frame data D_FRM from an external device. For example, the eternal device may include, but is not limited to, a Central Processing Unit (CPU), Graphics Processing Unit (GPU), etc. The timing control circuit 140 may provide frame data D_FRM to the column driver 120. The frame data D_FRM may include a plurality of pixel driving data PDD corresponding to different display pixels PX. The column driver 120 may divide the frame data D_FRM received from the timing control circuit 140 into pixel driving data PDD units and provide them to the display pixel array 110.

The timing control circuit 140 may control overall operations of the display device 100. For example, the timing control circuit 140 may control the operation timing of the column driver 120 and the row driver 130.

In an embodiment, the display device 100 may include an out-pixel memory circuit 150. For example, the out-pixel memory circuit 15 may be located outside the display pixel array 110. The out-pixel memory circuit 150 may store a portion of each of the plurality of pixel driving data PDD of the frame data D_FRM. For example, the out-pixel memory circuit 150 may temporarily store the portion of each of the plurality of pixel driving data PDD of the frame data D_FRM. For example, the timing control circuit 140 may temporarily store a first portion of each pixel driving data PDD in the out-pixel memory circuit 150 and provide a second portion of each pixel driving data PDD to the column driver 120. In this case, the column driver 120 may control one or more data lines DL based on bits included in the second part of each pixel driving data PDD. Thereafter, the timing control circuit 140 may read out the first part of each pixel driving data PDD from the out-pixel memory circuit 150 and provide them to the column driver 120. In this case, the column driver 120 may control one or more data lines DL based on bits included in the first part of each pixel driving data PDD. In this way, the column driver 120 may provide different portions of one pixel driving data PDD to the display pixels PX at different time intervals (e.g., with time divisional manner). However, the scope of the present disclosure is not limited thereto. For example, the display device 100 may be implemented so as not to include the out-pixel memory circuit 150, or the out-pixel memory circuit 150 may be implemented so as to store entire pixel driving data PDD.

In an embodiment, the out-pixel memory circuit 150 may be implemented as a volatile memory device such as a dynamic random access memory (DRAM), a static random access memory (SRAM), or the like. However, the scope of the present disclosure is not limited thereto, and the out-pixel memory circuit 150 may also be implemented as a non-volatile memory device such as a flash memory.

According to an embodiment, in an example case in which the out-pixel memory circuit 150 is implemented to store the entire pixel driving data PDD, the out-pixel memory circuit 150 may be referred to as a ‘frame buffer’. However, the scope of the present disclosure is not limited to these terms.

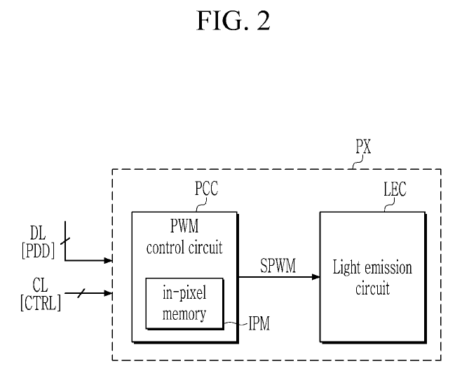

FIG. 2 is a block diagram showing the configuration of the display pixels of FIG. 1 in more detail. Referring to FIGS. 1 and 2, a display pixel PX may include a pulse width modulation (PWM) control circuit PCC and a light emission circuit LEC. The PWM control circuit PCC may include an in-pixel memory IPM.

In an embodiment, the in-pixel memory IPM may also be referred to as memory-in-pixel. However, the scope of the present disclosure is not limited to these terms.

The PWM control circuit PCC may receive pixel driving data PDD through one or more data lines DL and may receive the plurality of pixel control signals CTRL through one or more control lines CL.

The PWM control circuit PCC may generate a PWM signal SPWM corresponding to the pixel driving data PDD based on a plurality of pixel control signals CTRL. For example, the PWM control circuit PCC may generate a PWM signal SPWM corresponding to the pixel driving data PDD in response to a plurality of pixel control signals CTRL.

The PWM signal SPWM may include a plurality of bit emission periods (hereinafter referred to as “BEM”) having logic levels corresponding to a value of the pixel driving data PDD. The PWM control circuit PCC may determine the logic level of the PWM signal SPWM during the plurality of bit emission periods BEM based on bits included in pixel driving data PDD. For example, the PWM control circuit PCC may store one or more bits included in pixel driving data PDD into the in-pixel memory IPM based on the plurality of pixel control signals CTRL, and may determine a logic level of the PWM signal SPWM during bit emission periods BEM based on the one or more bits stored in the in-pixel memory IPM. For example, the PWM control circuit PCC may store the one or more bits included in pixel driving data PDD into the in-pixel memory IPM in response to the plurality of pixel control signals CTRL.

In an embodiment, each of the bits included in the pixel driving data PDD may be referred to as a ‘pixel driving bit’. However, the scope of the present disclosure is not limited to these terms.

The duty cycle (e.g., duty ratio) of the PWM signal SPWM may be determined according to a magnitude of the pixel driving data PDD. For example, as the magnitude of the pixel driving data PDD becomes greater, the PWM control circuit PCC may generate a PWM signal SPWM that has a greater proportion of time maintained at logic high, and as the magnitude of the pixel driving data PDD becomes smaller, the PWM control circuit PCC may generate the PWM signal SPWM that has a smaller proportion of time maintained at logic high. However, the scope of the present disclosure is not limited thereto.

According to an embodiment, the light emission circuit LEC may operate based on the PWM signal SPWM. For example, the light emission circuit LEC may operate in response to the PWM signal SPWM. For example, the light emission circuit LEC may include a light emitting diode that is turned on or off based on the logic level of the PWM signal SPWM.

A brightness of a display pixel PX perceived by human eye (e.g., the brightness of the light emission circuit LEC) may be determined based on a length of time the light emission circuit LEC emits light. The length of time the light emission circuit LEC emits light may be determined based on the pixel driving data PDD. Therefore, in order to finely adjust the brightness of the display pixel PX (e.g., in order to drive the display pixel PX with a higher luminance resolution), large capacity of pixel driving data PDD may be required. However, in order to generate the PWM signal SPWM corresponding to a large capacity of pixel driving data PDD, a large capacity of in-pixel memory IPM is generally required. Accordingly, it may be technically difficult to achieve high luminance resolution with a small area of display pixels PX.

The display pixel PX according to an embodiment of the present disclosure may generate the PWM signal SPWM corresponding to a large capacity of pixel driving data PDD based on a relatively small capacity of in-pixel memory IPM. For example, the capacity of an in-pixel memory IPM included in a display pixel PX according to an embodiment of the present disclosure may be smaller than the capacity of pixel driving data PDD. In this case, high luminance resolution may be achieved with a small area of display pixels PX. Therefore, according to the embodiment of the present disclosure, high luminance resolution may be implemented with small area of the display pixel array 110. According to an embodiment of the present disclosure, the display device 100 may be miniaturized.

For a more detailed example, the capacity of pixel driving data PDD may be greater than the capacity of in-pixel memory IPM. In this case, the PWM control circuit PCC may store a portion of pixel driving data PDD (e.g., one or more of the plurality of pixel driving bits) in the in-pixel memory IPM based on (or in response to) a plurality of pixel control signals CTRL, and may determine the logic level of one or more bit emission periods BEM based on stored bits of the pixel driving data PDD. Thereafter, the PWM control circuit PCC may update the in-pixel memory IPM based on the other portion included in the pixel driving data PDD (e.g., bits among the plurality of pixel driving bits that is not used to determine the logic level of the PWM signal SPWM yet). In this case, the PWM control circuit PCC may determine the logic level of one or more bit emission periods BEMs corresponding to the newly stored bits in the in-pixel memory IPM. An operation scheme of the display pixel PX in an example case in which the capacity of the pixel driving data PDD is greater than the capacity of the in-pixel memory IPM will be described in more detail below.

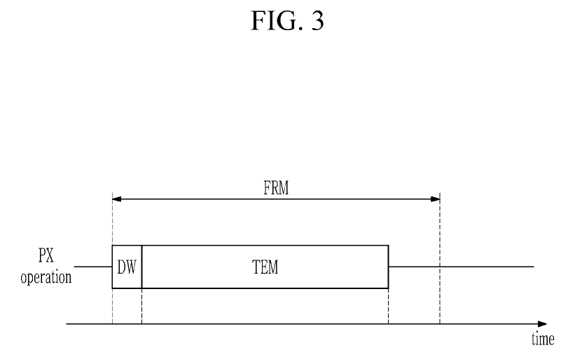

FIG. 3 is a timing diagram showing a driving method of a display pixel according to a comparative example. Referring to FIGS. 1-3, one frame period FRM may include a data writing period DW and a light emission period TEM. The data writing period DW may precede the light emission period TEM.

For the sake of brevity, an embodiment in which one frame period FRM includes one light emission period TEM is described below as a representative example, but the scope of the present disclosure is not limited thereto. For example, one frame period FRM may include a plurality of sub-frames, and each sub-frame may include one light emission period TEM.

The display pixel PX may store pixel driving data PDD in the in-pixel memory IPM during a data writing period DW. For example, the column driver 120 may provide bits included in the pixel driving data PDD to the display pixel PX through one or more data lines DL. The PWM control circuit PCC may store pixel driving data PDD indicated by the one or more data lines DL in the in-pixel memory IPM based on or in response to a plurality of pixel control signals CTRL.

The display pixel PX may perform light emission operation based on the pixel driving data PDD stored in the in-pixel memory IPM during the light emission period TEM. For example, the PWM control circuit PCC may perform the light emission operation based on the pixel driving data PDD stored in the in-pixel memory IPM based on or in response to the plurality of pixel control signals CTRL. For example, the PWM control circuit PCC may generate the PWM signal SPWM based on the pixel driving data PDD stored in the in-pixel memory IPM. The light emission circuit LEC may perform the light emission operation based on the PWM signal SPWM.

According to an embodiment of FIG. 3, after completing a data writing operation for the pixel driving data PDD into the in-pixel memory IPM, the display pixel PX may perform the light emission operation based on the pixel driving data PDD stored in the in-pixel memory IPM. In this case, the luminance resolution of the display pixel PX may be determined based on the pixel driving data PDD stored in the in-pixel memory IPM during the data writing period DW. Therefore, the luminance resolution implemented based on the display pixel PX may be limited by the capacity of the in-pixel memory IPM.

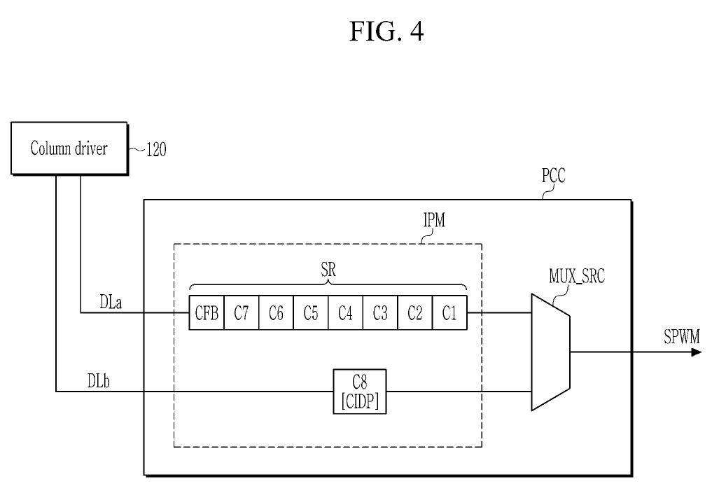

FIG. 4 is a block diagram showing in more detail the configuration of the PWM control circuit of FIG. 2 according to an embodiment of the present disclosure. Referring to FIGS. 1-4, the PWM control circuit PCC may include the in-pixel memory IPM and a source selection multiplexer MUX_SRC.

For a more concise explanation, an embodiment in which the in-pixel memory IPM has an 8-bit capacity is described below as a representative example. However, the scope of the present disclosure is not limited thereto. For example, in-pixel memory IPM may have a capacity of less than or more than 8 bits.

According to an embodiment, the in-pixel memory IPM may include a shift register SR and an independent bit cell CIDP. The shift register SR may include first to seventh bit cells C1 to C7 and a feedback cell CFB. The independent bit cell CIDP may include an eighth bit cell C8.

For simplicity, the following description assumes that the in-pixel memory IPM includes one independent bit cell CIDP. However, the scope of the present disclosure is not limited thereto. For example, the in-pixel memory IPM may include two or more independent bit cells CIDP.

The shift register SR and the independent bit cell CIDP may be connected to different data lines DL. For example, the shift register SR may be connected between a first data line DLa and the source selection multiplexer MUX_SRC, and the independent bit cell CIDP may be connected between a second data line DLb and the source selection multiplexer MUX_SRC. That is, the independent bit cell CIDP may be physically and electrically separated from the shift register SR.

The column driver 120 may provide different subsets of the pixel driving data PDD to the shift register SR and independent bit cell CIDP. For example, the column driver 120 may distribute a plurality of pixel driving bits included in the pixel driving data PDD to the first data line DLa and the second data line DLb.

The shift register SR may store a plurality of pixel driving bits provided from the first data line DLa in the first to seventh bit cells C1 to C7 and the feedback cell CFB. The shift register SR may output voltage level corresponding to a bit stored in the first bit cell C1 as an output signal. That is, the logic level of the output signal of the shift register SR may correspond to the bit stored in the first bit cell C1.

The independent bit cell CIDP may store a pixel driving bit provided from the second data line DLb. The independent bit cell CIDP may output a voltage level corresponding to a bit stored in the independent bit cell CIDP as an output signal. That is, the logic level of the output signal of the independent bit cell CIDP may correspond to the bit stored in the eighth bit cell C8.

The source selection multiplexer MUX_SRC may include a first input terminal connected to the shift register SR and a second input terminal connected to the independent bit cell CIDP. The source selection multiplexer MUX_SRC may include an output terminal that outputs the PWM signal SPWM. That is, the source selection multiplexer MUX_SRC may generate the PWM signal SPWM by multiplexing an output signal from the shift register SR and an output signal from the independent bit cell CIDP. In other words, the source selection multiplexer MUX_SRC may determine the logic level of the PWM signal SPWM based on the output signal from the shift register SR and the output signal from the independent bit cell CIDP.

Accordingly, while the logic level of the PWM signal SPWM is determined based on the bit stored in the independent bit cell CIDP, the output of the shift register SR may not affect the logic level of the PWM signal SPWM. For example, while the logic level of the PWM signal SPWM is determined based on the bit stored in the independent bit cell CIDP, even in an example case in which the data stored in the shift register SR changes, the logic level of the PWM signal SPWM may be only determined based on the bit stored in the eighth bit cell C8. Conversely, while the logic level of the PWM signal SPWM is determined based on the bit stored in the shift register SR, the output of the independent bit cell CIDP may not affect the logic level of the PWM signal SPWM. For example, while the logic level of the PWM signal SPWM is determined based on the bit stored in the shift register SR, even in an example case in which the data stored in the independent bit cell CIDP changes, the logic level of the PWM signal SPWM may be only determined based on the bit stored in the first bit cell C1. Below, based on the characteristics of the display pixel PX described above, a specific scheme of driving the display pixel PX based on the pixel driving data PDD having a larger capacity than the in-pixel memory IPM will be described.

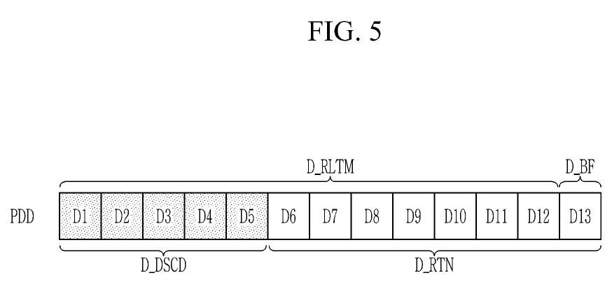

FIG. 5 is a diagram showing the configuration of pixel driving data according to an embodiment of the present disclosure. Referring to FIGS. 1-5, the pixel driving data PDD may include a plurality of pixel driving bits D. For example, the pixel driving data PDD may include first to thirteenth pixel driving bits D1 to D13.

The pixel driving data PDD may include discard data D_DSCD and retention data D_RTN. The discard data D_DSCD may be data that is deleted after being used for emitting light of the display pixel PX, and the retention data D_RTN may be data that is not deleted after being used for emitting light of the display pixel PX.

A code length of the retention data D_RTN may correspond to the capacity of the in-pixel memory IPM. For example, the retention data D_RTN may include the sixth to thirteenth pixel driving bits D6 to D13.

The code length of the discard data D_DSCD may correspond to a value obtained by subtracting the capacity of the in-pixel memory IPM from the code length of the pixel driving data PDD. For example, the discard data D_DSCD may include the first to fifth pixel driving bits D1 to D5.

In an embodiment, the discard data D_DSCD may be implemented as lower bits of the pixel driving data PDD, and the retention data D_RTN may be implemented as upper bits of the pixel driving data PDD. For example, the discard data D_DSCD may be implemented with the lower 5 bits of the pixel driving data PDD, and the retention data D_RTN may be implemented with the upper 8 bits of the pixel driving data PDD. The lower bits of the pixel driving data PDD may be used to determine logic level of bit emission periods BEM, which has relatively short time length. Accordingly, the discard data D_DSCD may be quickly discarded from the display pixel PX, and the retention data D_RTN may then be newly stored in the display pixel PX. Additionally, in an example case in which the display pixel PX is implemented to use the retention data D_RTN with a plurality of times for determining logic level of the PWM signal SPWM (for example, if the display pixel PX is driven in a sub-frame manner), the brightness change of the display pixel PX may be minimized even if the discard data D_DSCD is deleted from the display pixel PX. However, the scope of the present disclosure is not limited thereto.

The pixel driving data PDD may include real-time data D_RLTM and buffer data D_BF. The timing control circuit 140 may store some bits of the pixel driving data PDD in the out-pixel memory circuit 150 and may provide other bits of the pixel driving data PDD directly to the column driver 120. After a certain amount of time has elapsed, the timing control circuit 140 may read out a portion of the pixel driving data PDD from the out-pixel memory circuit 150 and may provide the read out bits to the column driver 120. In this case, the column driver 120 may be able to receive the real-time data D_RLTM and the buffer data D_BF included in one pixel driving data PDD at different time points.

For a more detailed example, the real-time data D_RLTM may include the first to twelfth pixel driving bits D1 to D12, and the buffer data D_BF may include the thirteenth pixel driving bit D13. However, the scope of the present disclosure is not limited thereto.

In an embodiment, the buffer data D_BF may be implemented as one or more upper bits of the pixel driving data PDD. For example, the buffer data D_BF may include the thirteenth pixel driving bit D13, which is the MSB of the pixel driving data PDD.

In an embodiment, the pixel driving data PDD may not include buffer data D_BF. For example, the timing control circuit 140 may directly provide the entire frame data D_FRM provided from the outside to the column driver 120.

In an embodiment, one or more pixel driving bits D may be included in both real-time data D_RLTM and buffer data D_BF. For example, the timing control circuit 140 may be implemented to provide a specific pixel driving bit D to the column driver 120 in real time, and may back up the specific pixel driving bit D to the out-pixel memory circuit 150. However, the scope of the present disclosure is not limited thereto.

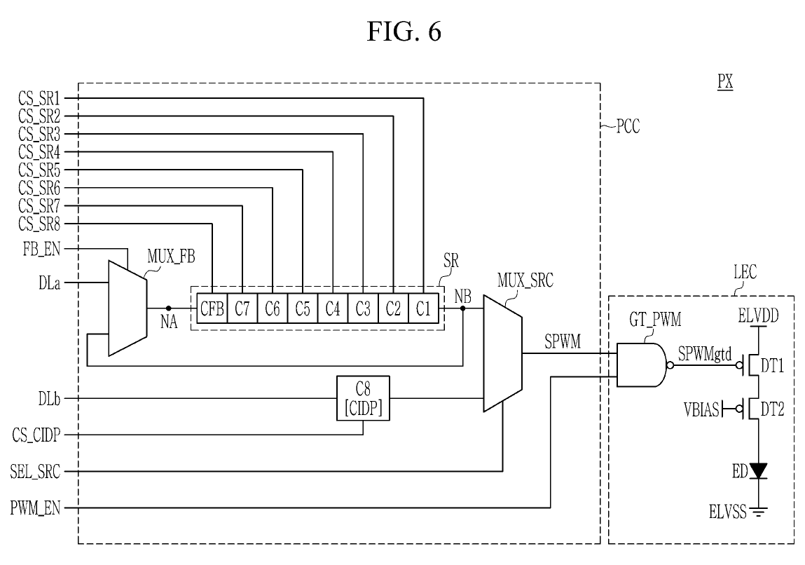

FIG. 6 is a circuit diagram showing a configuration of display pixel according to an embodiment of the present disclosure in more detail. Referring to FIGS. 1-6, a display pixel PX may include the PWM control circuit PCC and the light emission circuit LEC.

The PWM control circuit PCC may include a feedback multiplexer MUX_FB, the shift register SR, the independent bit cell CIDP, and the source selection multiplexer MUX_SRC.

The pixel control signals CTRL may include one or more shift register control signals CS_SR, a feedback enable signal FB_EN, an independent bit cell control signal CS_CIDP, a source selection signal SEL_SRC, and a PWM enable signal PWM_EN.

A first input terminal of the feedback multiplexer MUX_FB may be connected to the first data line DLa. The output terminal of the feedback multiplexer MUX_FB may be connected to a first node NA. The first node NA may be connected to the input terminal of the shift register SR. The second input terminal of the feedback multiplexer MUX_FB may be connected to a second node NB. The second node NB may be connected to an output terminal of the shift register SR.

The feedback multiplexer MUX_FB may operate based on the feedback enable signal FB_EN. For example, the feedback multiplexer MUX_FB may operate in response to the feedback enable signal FB_EN. For example, the feedback multiplexer MUX_FB may determine the logic level of the first node NA based on the logic level of the first data line DLa while the logic level of the feedback enable signal FB_EN is logic low. The feedback multiplexer MUX_FB may determine the logic level of the first node NA based on the logic level of the second input terminal (e.g., a second node NB) while the logic level of the feedback enable signal FB_EN is logic high. For example, while the logic level of the feedback enable signal FB_EN is logic low, the output at the first node NA is based on the first data line DLa, and while the logic level of the feedback enable signal FB_EN is logic high, the output at the first node NA is based on the logic level at the second node NB.

The shift register SR may be connected between the first node NA and the second node NB. The shift register SR may include the feedback cell CFB and first to seventh bit cells C1 to C7 connected in series between the first node NA and the second node NB. The feedback cell CFB may be connected to the first node NA, and the first bit cell C1 may be connected to the second node NB.

For a more concise explanation, an embodiment in which the feedback cell CFB is placed between the feedback multiplexer MUX_FB and the seventh bit cell C7 is described below as a representative example. However, the scope of the present disclosure is not limited thereto. For example, the feedback cell CFB may be placed between the first bit cell C1 and the source selection multiplexer MUX_SRC.

The independent bit cell CIDP may include the eighth bit cell C8. That is, the independent bit cell CIDP may be implemented to store 1 bit. However, the scope of the present disclosure is not limited thereto.

Each of the first to eighth bit cells C1 to C8 and the feedback cell CFB may be implemented as a latch. For example, the first to seventh bit cells C1 to C7 and the feedback cell CFB may be implemented as latches configured to change stored bit values based on or in response to the first to eighth shift register control signals CS_SR1 to CS_SR8, respectively. The eighth bit cell C8 may be implemented as a latch configured to change a stored data value based on in response to the independent bit cell control signal CS_CIDP. However, the scope of the present disclosure is not limited thereto, and each of the first to eighth bit cells C1 to C8 and the feedback cell CFB may be implemented as any type of data storage element, such as a flip-flop. In an example case in which each of the first to seventh bit cells C1 to C7 and the feedback cell CFB is implemented as a flip-flop, the first to seventh bit cells C1 to C7 and the feedback cell CFB may be implemented to share one shift register control signal CS_SR.

In an embodiment, each of the first to seventh bit cells C1 to C7 may be referred to as ‘a serial bit cell’ or ‘a serial latch’. The eighth bit cell C8 may be referred to as ‘an independent bit cell’ or ‘an independent latch’. However, the scope of the present disclosure is not limited to these terms.

In an embodiment, the feedback cell CFB may operate based on the eighth shift register control signal CS_SR8. For example, the feedback cell CFB may operate in response to the eighth shift register control signal CS_SR8. From this perspective, the eighth shift register control signal CS_SR8 may also be referred to as a “shift register feedback control signal.” However, the scope of the present disclosure is not limited to these terms.

The shift register SR may receive a plurality of pixel driving bits D from the first data line DLa through the feedback multiplexer MUX_FB based on the first to eighth shift register control signals CS_SR1 to CS_SR8. For example, the shift register SR may sequentially receive the plurality of pixel driving bits D one by one, in response to the first to eighth shift register control signals CS_SR1 to CS_SR8 and store the plurality of pixel driving bits D in the first to seventh bit cells C1 to C7 and the feedback cell CFB.

The independent bit cell CIDP may store a bit indicated by the second data line DLb. For example, an independent bit cell CIDP may receive and store a pixel driving bit D from the second data line DLb based on or in response to the independent bit cell control signal CS_CIDP.

The logic level of the output signal of the shift register SR may correspond to the bit stored in the first bit cell C1. The logic level of the output signal of the independent bit cell CIDP may correspond to the bit stored in the eighth bit cell C8.

In an embodiment, the shift register SR may perform a bit rotation operation for the first to seventh bit cells C1 to C7 based on control of the row driver 130. For example, in response to the first to eighth shift register control signals CS_SR1 to CS_SR8, the shift register SR may move bits stored in the second to seventh bit cells C2 to C7 to the first to sixth bit cells C1 to C6, may move bits stored in the feedback cell CFB to the seventh bit cell C7, and may copy a bit stored in the first bit cell C1 to the feedback cell CFB. Accordingly, the bits stored in the first to seventh bit cells C1 to C7 may be rotated (or shifted), and the feedback cell CFB may store the same bit as the first bit cell C1. However, the scope of the present disclosure is not limited thereto.

In an embodiment, the feedback cell CFB may be used to temporarily store a pixel driving bit D stored in the first bit cell C1 for the bit rotation operation of the shift register SR, or to transfer a pixel driving bit D provided from the feedback multiplexer MUX_FB to the first to seventh bit cells C1 to C7. That is, the feedback cell CFB may be implemented to temporarily store a pixel driving bit for the operation of the shift register SR. However, the scope of the present disclosure is not limited thereto.

In an embodiment, the capacity of the in-pixel memory IPM may correspond to the sum of the number of pixel driving bits that may be stored in the shift register SR (e.g., 7, which is the number of bits that may be stored in the first to seventh bit cells C1 to C7) and the number of pixel driving bits that may be stored in the independent bit cell CIDP (e.g., 1, which is the number of bits that may be stored in the eighth bit cell C8). That is, when determining the capacity of the in-pixel memory IPM, a number of bits that may be stored in the feedback cell CFB may not be included in the capacity. However, the scope of the present disclosure is not limited thereto.

The first input terminal of the source selection multiplexer MUX_SRC may be connected to the second node NB (or, the first bit cell C1). That is, the first input terminal of the source selection multiplexer MUX_SRC may receive the output signal from the shift register SR.

The second input terminal of the source selection multiplexer MUX_SRC may be connected to the eighth bit cell C8. That is, the second input terminal of the source selection multiplexer MUX_SRC may receive an output signal from the independent bit cell CIDP.

The output terminal of the source selection multiplexer MUX_SRC may output the PWM signal SPWM. That is, the source selection multiplexer MUX_SRC may determine the logic level of the PWM signal SPWM based on the logic level of the first input terminal and the logic level of the second input terminal.

According to an embodiment, the source selection multiplexer MUX_SRC may operate based on the source selection signal SEL_SRC. For example, the source selection multiplexer MUX_SRC may operate in response to the source selection signal SEL_SRC. For example, the source selection multiplexer MUX_SRC may determine the logic level of the PWM signal SPWM based on the bit stored in the first bit cell C1 while the logic level of the source selection signal SEL_SRC is logic low. The source selection multiplexer MUX_SRC may determine the logic level of the PWM signal SPWM based on the bit stored in the eighth bit cell C8 while the logic level of the source selection signal SEL_SRC is logic high.

In an embodiment, the row driver 130 may control the display pixels PX to sequentially change the pixel driving bits D stored in the first bit cell C1 and the eighth bit cell C8. In this case, the pixel driving bit D used to determine the logic level of the PWM signal SPWM may be sequentially changed. In this way, the row driver 130 may control the plurality of pixel control signals CTRL to cause the source selection multiplexer MUX_SRC to generate a PWM signal SPWM including the plurality of bit emission periods BEM.

In an embodiment, the row driver 130 may freely determine the time period at which the logic level of the PWM signal SPWM is determined based on the bit stored in the independent bit cell CIDP (e.g., regardless of the order with other bit emission periods BEM). For example, the row driver 130 may divide a bit emission period BEM corresponding to a bit stored in the independent bit cell CIDP into a plurality of sub-bit emission periods (hereinafter, referred to as “SUB_BEM”). Accordingly, during one light emission period TEM, a number of times the source selection multiplexer MUX_SRC determines the logic level of the PWM signal SPWM based on the bit stored in the independent bit cell CIDP can be two or more. In this case, various problems such as a false contour effect, etc., caused by lengths of the bit emission periods BEM may be minimized, so the quality of the image generated by the display device 100 may be improved. However, the scope of the present disclosure is not limited thereto, and the row driver 130 may not divide the bit emission period BEM corresponding to the bit stored in the independent bit cell CIDP.

The light emission circuit LEC may include a PWM gate GT_PWM, a first drive transistor DT1, a second drive transistor DT2, and a light emitting diode ED.

The PWM gate GT_PWM may gate the PWM signal SPWM based on the PWM enable signal PWM_EN. For example, the PWM gate GT_PWM may gate the PWM signal SPWM in response to the PWM enable signal PWM_EN. For example, in response to the PWM enable signal PWM_EN, the PWM gate GT_PWM may generate a gated PWM signal SPWMgtd by gating the PWM signal SPWM.

The first drive transistor DT1 and the second drive transistor DT2 may be connected in series between the power supply voltage ELVDD and the light emitting diode ED. The light emitting diode ED may be connected to ground voltage ELVSS. The gate terminal of the first drive transistor DT1 may receive a gated PWM signal SPWMgtd. The gate terminal of the second drive transistor DT2 may receive a bias voltage VBIAS.

The first drive transistor DT1 may provide the power supply voltage ELVDD to the second drive transistor DT2 during a period at which the gated PWM signal SPWMgtd is logic low. In this case, current may be supplied to the light emitting diode ED through the second drive transistor DT2, and the light emitting diode ED may be turned on (e.g., generate light).

The first drive transistor DT1 may electrically isolate the power supply voltage ELVDD from the second drive transistor DT2 during a time period at which the gated PWM signal SPWMgtd is logic high. In this case, the second drive transistor DT2 may be turned off, so the light emitting diode ED may be turned off. For example, the light emitting diode ED may not generate light.

In an embodiment, the first drive transistor DT1 and the second drive transistor DT2 may be implemented as a p-type channel metal-oxide semiconductor transistor (PMOS). In this case, the PWM gate GT_PWM may perform logical NAND operation. For example, the PWM gate GT_PWM may determine the gated PWM signal SPWMgtd to be logic high while the PWM enable signal PWM_EN is logic low, and may determine the gated PWM signal SPWMgtd to be the opposite logic level of the PWM signal SPWM while the PWM enable signal PWM_EN is logic high. However, the scope of the present disclosure is not limited thereto. For example, the first drive transistor DT1 and the second drive transistor DT2 may be implemented as a n-type channel metal-oxide semiconductor transistor (NMOS). In this case, the PWM gate GT_PWM may perform a logical AND operation.

In an embodiment, the light emission circuit LEC may not include the second drive transistor DT2. For example, the light emitting diode ED may be directly connected to the first drive transistor DT1. That is, the scope of the present disclosure is not limited to a specific implementation method of a light emission circuit LEC.

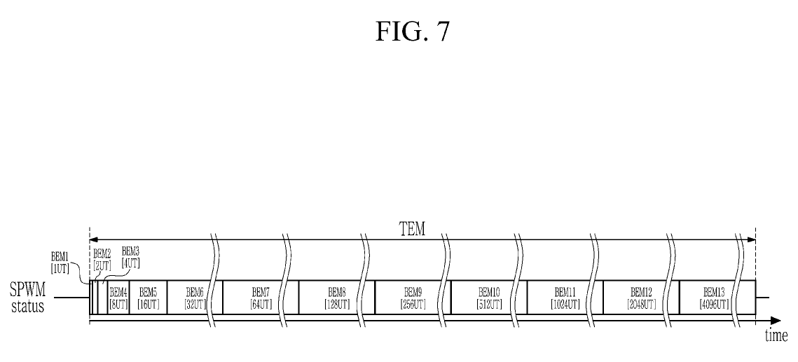

FIG. 7 is a drawing showing in more detail the configuration of a PWM signal according to an embodiment. Referring to FIGS. 1-7, the display pixel PX may operate based on pixel driving data PDD of 13 bit size. For a more concise explanation, the configuration of one light emission period TEM included in one frame period FRM will be described as a representative example below.

According to an embodiment, the light emission circuit LEC emits light during the light emitting period TEM based on the logic level of the PWM signal SPWM. For example, the light emission circuit LEC may determine whether to emit light during the light emitting period TEM based on the logic level of the PWM signal SPWM. The light emission period TEM may include a plurality of bit emission periods BEM. Each of the plurality of bit emission periods BEMs may correspond to different bits included in the pixel driving data PDD. For example, the light emission period TEM may include first to thirteenth bit emission periods BEM1 to BEM13 corresponding to the first to thirteenth pixel driving bits D1 to D13, respectively.

For a more concise explanation, an embodiment in which the first to thirteenth bit emission periods BEM1 to BEM13 are sequentially arranged within the light emission period TEM is described below as a representative example. However, the scope of the present disclosure is not limited thereto. For example, the first to thirteenth bit emission periods BEM1 to BEM13 may be arranged in any order within the light emission period TEM.

Referring to FIG. 7, the time lengths of the first to thirteenth bit emission periods BEM1 to BEM13 may form a geometric sequence with a common ratio of 2. For example, the time length of the first bit emission period BEM1 may be ‘1UT’, and the time length of the second bit emission period BEM2 may be ‘2UT’. In this way, the time length of the thirteenth bit emission period BEM13 may be ‘4096UT’. However, the scope of the present disclosure is not limited thereto. For example, the time length of each of the first to thirteenth bit emission periods BEM1 to BEM13 may form an arbitrary type of sequence other than a geometric sequence.

In an embodiment, ‘1UT’ may be a unit used to describe the relative length of the plurality of bit emission periods BEMs. However, the scope of the present disclosure is not limited to a specific time length of ‘1UT’.

The PWM control circuit PCC may determine the logic level of the PWM signal SPWM of each of the first to eighth bit emission periods BEM1 to BEM8 based on corresponding pixel driving bit D. For example, the PWM control circuit PCC may determine the logic level of the PWM signal SPWM during the first bit emission period BEM1 based on LSB (e.g., the first pixel driving bit D1) of the pixel driving data PDD, and may determine the logic level of the PWM signal SPWM during the thirteenth bit emission period BEM13 based on the MSB (e.g., the thirteenth pixel driving bit D13) of the pixel driving data PDD.

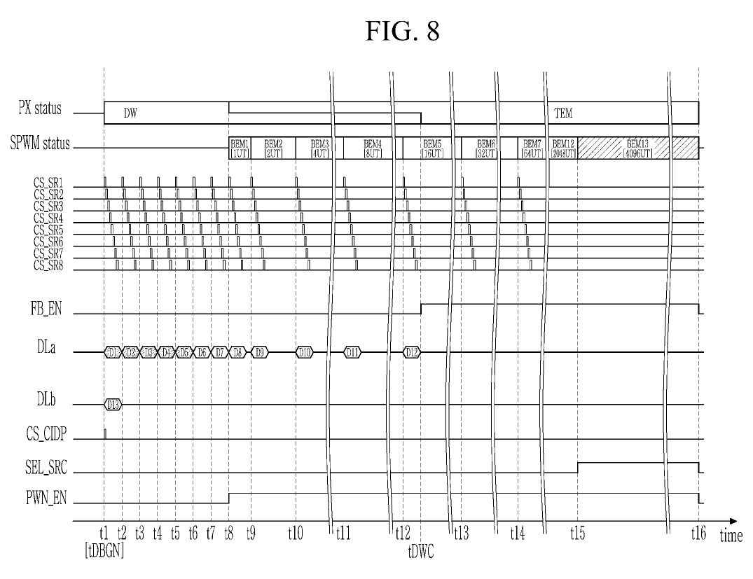

FIGS. 8-11 are timing diagrams showing in detail the operation of a display device according to various embodiments of the present disclosure. Hereinafter, with reference to FIGS. 1-11, different methods of driving a display pixel PX during one frame period FRM according to the embodiment of FIG. 7 will be described. For a more concise explanation below, it may be assumed that the display pixel PX includes an in-pixel memory IPM of 8 bits and operates based on pixel driving data PDD of 13 bits, and the column driver 120 provides the MSB (e.g., the thirteenth pixel driving bit D13) of the pixel driving data PDD to the second data line DLb.

Referring to FIG. 8, the column driver 120 may output the first to twelfth pixel driving bits D1 to D12 through the first data line DLa, and may output the thirteenth pixel driving bit D13 through the second data line DLb. That is, the column driver 120 may output only one pixel driving bit D through the second data line DLb.

During the data writing period DW, the display pixel PX may store the plurality of pixel driving bits D in the shift register SR and the independent bit cell CIDP. During the light emission period TEM, the display pixel PX may perform an emission operation based on pixel driving bits D stored in the in-pixel memory IPM. A method by which display pixels PX are driven according to an embodiment is described in detail.

The row driver 130 may set the feedback enable signal FB_EN to logic low during the data writing period DW. For example, the row driver 130 may set the feedback enable signal FB_EN to logic low between the first time point t1 and the data writing completion time point tDWC. In this case, the feedback multiplexer MUX_FB may be able to provide the logic level indicated by the first data line DLa to the shift register SR.

For example, between the first time point t1 and the eighth time point t8, the column driver 120 may sequentially provide the first to seventh pixel driving bits D1 to D7 to the first data line DLa. In this case, the shift register SR may sequentially store the first to seventh pixel driving bits D1 to D7 through the feedback multiplexer MUX_FB based on the control of the row driver 130.

According to an embodiment, between a first time point t1 and a second time point t2, the column driver 120 may provide a first pixel driving bit D1 to the first data line DLa. The row driver 130 may sequentially toggle the first to eighth shift register control signals CS_SR1 to CS_SR8 (e.g., transition from logic low to logic high, and then transition back to logic low). In this case, the first pixel driving bit D1 may be stored in the feedback cell CFB.

Thereafter, between the second time point t2 and the third time point t3, the column driver 120 may provide the second pixel driving bit D2 to the first data line DLa. The row driver 130 may sequentially toggle the first to eighth shift register control signals CS_SR1 to CS_SR8. In this case, the first pixel driving bit D1 stored in the feedback cell CFB may be shifted to the seventh bit cell C7, and the second pixel driving bit D2 may be newly stored in the feedback cell CFB.

In this way, the column driver 120 may sequentially provide the third to seventh pixel driving bits D3 to D7 to the first data line DLa between the third time point t3 and the eighth time point t8. The row driver 130 may sequentially store the third to seventh pixel driving bits D3 to D7 in the shift register SR by controlling the first to eighth shift register control signals CS_SR1 to CS_SR8. Accordingly, at the eighth time point t8, the first to sixth pixel driving bits D1 to D6 may be stored in the second to seventh bit cells C2 to C7, respectively, and the seventh bit D7 may be stored in the feedback cell CFB.

In an embodiment, a time point at which the display pixel PX begins to be driven within one frame period FRM may be referred to as a driving beginning time point tDBGN. For example, the driving beginning time point tDBGN may refer to the first time t1 at which the column driver 120 starts to provide the pixel driving bit D through the first data line DLa.

For a more concise explanation, FIG. 7 is representatively described as an embodiment in which the row driver 130 sequentially toggles all of the first to eighth shift register control signals CS_SR1 to CS_SR8 each time a new bit is stored in the shift register SR, but the scope of the present disclosure is not limited thereto. For example, between a first time point t1 and a second time point t2, the row driver 130 may store the first pixel driving bit D1 in the feedback cell CFB by toggling only the eighth shift register control signal CS_SR8. Similarly, between the second time point t2 and the eighth time point t8, the row driver 130 may store the first to seventh pixel driving bits D1 to D7 in the shift register SR without toggling some of the shift register control signals CS_SR. In this case, the power consumption of the row driver 130 may be minimized.

The row driver 130 may set the PWM enable signal PWM_EN to logic high during the light emission period TEM. For example, the row driver 130 may set the PWM enable signal PWM_EN to logic high between the eighth time point t8 and the sixteenth time point t16. In this case, the PWM gate GT_PWM may determine the logic level of the gated PWM signal SPWMgtd based on the logic level of the PWM signal SPWM. For example, the PWM gate GT_PWM may determine the logic level of the gated PWM signal SPWMgtd by inverting the the logic level of the PWM signal SPWM.

The light emission period TEM may include first to thirteenth bit emission periods BEM1 to BEM13. The source selection multiplexer MUX_SRC may determine the logic level of a PWM signal SPWM of the first to twelfth bit emission periods BEM1 to BEM12 based on an output signal from the shift register SR, and may determine the logic level of a PWM signal SPWM of the thirteenth bit emission period BEM13 based on the output signal from the independent bit cell CIDP. For example, the row driver 130 may set the source selection signal SEL_SRC to logic low between the eighth time point t8 and the fifteenth time point t15 corresponding to the first to twelfth bit emission periods BEM1 to BEM12, and may set the source selection signal SEL_SRC to logic high between the fifteenth time point t15 and the sixteenth time point t16 corresponding to the thirteenth bit emission period BEM13.

During a time period between the eighth time point t8 and the ninth time point t9 corresponding to the first bit emission period BEM1, the PWM control circuit PCC may determine the logic level of the PWM signal SPWM based on the first pixel driving bit D1 and write the eighth pixel driving bit D8 to the shift register SR. For example, the column driver 120 may provide the eighth pixel driving bit D8 to the first data line DLa at the eighth time point t8. The row driver 130 may sequentially toggle the first to eighth shift register control signals CS_SR1 to CS_SR8. In this case, the first to seventh pixel driving bits D1 to D7 may be stored in the first to seventh bit cells C1 to C7, respectively, and the eighth pixel driving bit D8 may be written to the feedback cell CFB. And, as the source selection signal SEL_SRC is logic low, the source selection multiplexer MUX_SRC may determine the logic level of the PWM signal SPWM during the first bit emission period BEM1 based on the first pixel driving bit D1 stored in the first bit cell C1.

Thereafter, during a time period between the ninth time point t9 and the tenth time point t10 corresponding to the second bit emission period BEM2, the shift register SR may delete the first pixel driving bit D1 and newly store the ninth pixel driving bit D9, and the PWM control circuit PCC may determine the logic level of the PWM signal SPWM based on the second pixel driving bit D2. For example, the column driver 120 may provide the ninth pixel driving bit D9 to the first data line DLa at the ninth time point t9. The row driver 130 may sequentially toggle the first to eighth shift register control signals CS_SR1 to CS_SR8. In this case, the first pixel driving bit D1 stored in the first bit cell C1 may be deleted, the second to eighth pixel driving bits D2 to D8 stored in the second to seventh bit cells C2 to C7 and the feedback cell CFB may be shifted to the first to seventh bit cells C1 to C7, and the ninth pixel driving bit D9 may be newly stored in the feedback cell CFB. As the first bit cell C1 is updated with the second pixel driving bit D2, the source selection multiplexer MUX_SRC may determine the logic level of the PWM signal SPWM based on the second pixel driving bit D2 during the second bit emission period BEM2.

In this way, during the time period between the tenth time point t10 and the thirteenth time point t13 corresponding to the third to fifth bit emission periods BEM3 to BEM5, the shift register SR may delete the second to fourth pixel driving bits D2 to D4 and newly store the tenth to twelfth pixel driving bits D10 to D12. The PWM control circuit PCC may determine the logic level of the PWM signal SPWM based on the third to fifth pixel driving bits D3 to D5 during the third to fifth bit emission periods BEM3 to BEM5, respectively.

According to an embodiment, the row driver 130 may transition the feedback enable signal FB_EN to logic high at the data writing completion time point tDWC. According to an embodiment, after the data writing completion time point tDWC, the row driver 130 may maintain the feedback enable signal FB_EN at logic high. In this case, the feedback multiplexer MUX_FB may provide pixel driving bit D stored in the first bit cell C1 to the feedback cell CFB.

During the sixth bit emission period BEM6, the PWM control circuit PCC may determine the logic level of the PWM signal SPWM based on the sixth pixel driving bit D6. For example, at the thirteenth time point t13, the row driver 130 may toggle the first shift register control signal CS_SR1. In this case, the fifth pixel driving bit D5 may be deleted from the first bit cell C1, and the sixth pixel driving bit D6 stored in the second bit cell C2 may be newly stored in the first bit cell C1. Accordingly, the logic level of the PWM signal SPWM may be determined based on the sixth pixel driving bit D6.

After the sixth pixel driving bit D6 is stored in the first bit cell C1, the row driver 130 may store the seventh to twelfth pixel driving bits D2 to D12 in the second to seventh bit cells C2 to C7, by sequentially toggling the second to seventh shift register control signals CS_SR2 to CS_SR7, respectively. Thereafter, the row driver 130 may copy the sixth pixel driving bit D6 stored in the first bit cell C1 to the feedback cell CFB by toggling the eighth shift register control signal CS_SR8.

In a similar manner, the row driver 130 may sequentially rotate the shift register SR one-by-one, during a time period between the fourteenth time point t14 and the fifteenth time point t15 corresponding to the seventh to twelfth bit emission periods BEM7 to BEM12. In this way, the logic level of the PWM signal SPWM during the seventh to twelfth bit emission periods BEM7 to BEM12 may be determined based on the seventh to twelfth pixel driving bits D7 to D12, respectively.

Meanwhile, before the fifteenth time point t15, the column driver 120 may provide the thirteenth pixel driving bit D13 to the second data line DLb. For example, the column driver 120 may output the thirteenth pixel driving bit D13 to the second data line DLb between the first time point t1 and the second time point t2. In this case, the row driver 130 may toggle the independent bit cell control signal CS_CIDP at the first time point t1. In this case, the thirteenth pixel driving bit D13 may be stored in the independent bit cell CIDP. However, the disclosure is not limited thereto, and as such, the column driver 120 may provide the thirteenth pixel driving bit D13 to the second data line DLb before the fifteenth time point t15.

For a more concise explanation, FIG. 8 illustrates an embodiment in which the column driver 120 outputs the thirteenth pixel driving bit D13 between the first time point t1 and the second time point t2, but the scope of the present disclosure is not limited thereto. For example, the column driver 120 may output the thirteenth pixel driving bit D13 at any time period positioned between the first time point t1 and the fifteenth time point t15.

During the time period between the fifteenth time point t15 and the sixteenth time point t16 corresponding to the thirteenth bit emission period BEM13, the row driver 130 may set the source selection signal SEL_SRC to logic high. In this case, the source selection multiplexer MUX_SRC may determine the logic level of the PWM signal SPWM based on the thirteenth pixel driving bit D13 stored in the independent bit cell CIDP.

That is, the first to fifth pixel driving bits D1 to D5 corresponding to the discard data D_DSCD may be deleted from the in-pixel memory IPM, and the sixth to thirteenth pixel driving bits D6 to D13 corresponding to the retention data D_RTN may not be deleted from the in-pixel memory IPM.

In an embodiment, the row driver 130 may determine each time interval between the first to sixteenth time points t1 to t16 to be a predetermined length. For example, the row driver 130 may control the timing of changing the logic levels of the plurality of pixel control signals CTRL based on the length of the bit emission periods BEM described above with reference to FIG. 7.

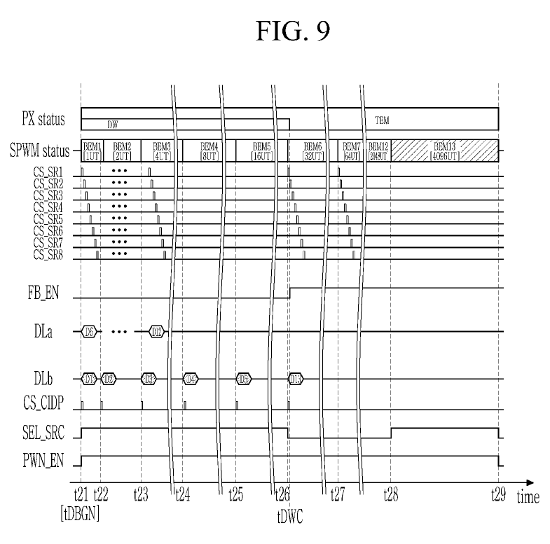

Next, referring to FIG. 9, the column driver 120 may output the sixth to twelfth pixel driving bits D6 to D12 through the first data line DLa, and may output the first to fifth pixel driving bits D1 to D5 and the thirteenth pixel driving bit D13 through the second data line DLb. That is, the column driver 120 may output entire discard data D_DSCD through the second data line DLb. Below, the differences from the driving method of the display pixel PX described above with reference to FIG. 8 will be explained in detail.

The row driver 130 may set the feedback enable signal FB_EN to logic low during the data writing period DW. For example, the row driver 130 may set the feedback enable signal FB_EN to logic low between the twenty-first time point t21 (e.g. , the driving beginning time point tDBGN) and the data writing completion time point tDWC. The row driver 130 may set the feedback enable signal FB_EN to logic high after the data writing period DW is completed. For example, the row driver 130 may set the feedback enable signal FB_EN to logic high between the data writing completion time point tDWC and the twenty-ninth time point t29.

The row driver 130 may set the PWM enable signal PWM_EN to logic high during the light emission period TEM. For example, the row driver 130 may set the PWM enable signal PWM_EN to logic high between the twenty-first time point t21 and the twenty-ninth time point t29.

The light emission period TEM may include first to thirteenth bit emission periods BEM1 to BEM13. The row driver 130 may set the source selection signal SEL_SRC to logic high between the twenty-first time point t21 and the twenty-sixth time point t26 corresponding to the first to fifth bit emission periods BEM1 to BEM5; may set the source selection signal SEL_SRC to logic low between the twenty-sixth time point t26 and the twenty-eighth time point t28 corresponding to the sixth to twelfth bit emission periods BEM6 to BEM12; and may set the source selection signal SEL_SRC to logic high between the twenty-eighth time point t28 and the twenty-ninth time point t29 corresponding to the thirteenth bit emission period BEM13.

The column driver 120 may sequentially provide the first to fifth pixel driving bits D1 to D5 to the second data line DLb. The display pixel PX may determine the logic level of the PWM signal SPWM during the first to fifth bit emission periods BEM1 to BEM5 based on the first to fifth pixel driving bits D1 to D5, respectively, based on the control of the row driver 130.

According to an embodiment, the column driver 120 may provide the first pixel driving bit D1 to the second data line DLb at the twenty-first time point t21. The row driver 130 may store the first pixel driving bit D1 in the independent bit cell CIDP by toggling the independent bit cell control signal CS_CIDP at the twenty-first time point t21. In this case, since the source selection signal SEL_SRC and the PWM enable signal PWM_EN are logic high, the logic level of the PWM signal SPWM may be directly determined based on the first pixel driving bit D1. In this way, the logic level of the PWM signal SPWM during the first bit emission period BEM1 may be determined based on the first pixel driving bit D1.

Similarly, the column driver 120 may provide the second to fifth pixel driving bits D2 to D5 to the second data line DLb at the twenty-second time point t22 to the twenty-fifth time point t25, respectively; so the logic level of the PWM signal SPWM during the second to fifth bit emission periods BEM2 to BEM5 may be determined based on the second to fifth pixel driving bits D2 to D5, respectively.

In an embodiment, the row driver 130 and the column driver 120 may be implemented to transition the logic level of the PWM signal SPWM in real time based on the voltage level of the second data line DLb. For example, the row driver 130 may maintain the independent bit cell control signal CS_CIDP at logic high during the first to fifth bit emission periods BEM2 to BEM5. The column driver 120 may maintain the voltage level of the second data line DLb at a value corresponding to the first to fifth pixel driving bits D1 to D5 in the first to fifth bit emission periods BEM2 to BEM5. In this case, the logic level of the PWM signal SPWM may transition based on a voltage level change of the second data line DLb. For example, the logic level of the PWM signal SPWM may immediately transition in response to the voltage level change of the second data line DLb. That is, the scope of the present disclosure is not limited to a specific driving method that allows the logic level of a PWM signal SPWM to be determined in real time based on pixel driving bits provided to the display pixel PX through the second data line DLb.

The column driver 120 may provide the thirteenth pixel driving bit D13 to the second data line DLb before the twenty-eighth time point t28 at which the thirteenth bit emission period BEM13 begins. For example, between the twenty-sixth time point t26 and the twenty-seventh time point t27, the column driver 120 may output the thirteenth pixel driving bit D13 to the second data line DLb and the row driver 130 may toggle the independent bit cell control signal CS_CIDP. In this case, the thirteenth pixel driving bit D13 may be stored in an independent bit cell CIDP.

Meanwhile, the column driver 120 may provide the sixth to twelfth pixel driving bits D6 to D12 to the first data line DLa before the twenty-sixth time point t26 at which the sixth bit emission period BEM6 begins. For example, the column driver 120 may provide the sixth pixel driving bit D6 to the first data line DLa at the twenty-first time point t21. The row driver 130 may store the sixth pixel driving bit D6 in the shift register SR by sequentially toggling the first to eighth shift register control signals CS_SR1 to CS_SR8. Thereafter, in a similar manner, the column driver 120 may sequentially provide the seventh to twelfth pixel driving bits D7 to D12 to the first data line DLa, and the row driver 130 may sequentially store the seventh to twelfth pixel driving bits D7 to D12 in the shift register SR by controlling the first to eighth shift register control signals CS_SR1 to CS_SR8. Accordingly, before the twenty-sixth time point t26, the second to seventh bit cells C2 to C7 and the feedback cell CFB may store the sixth to twelfth pixel driving bits D6 to D12, respectively.

During a time period between the twenty-sixth time point t26 and the twenty-seventh time point t27 corresponding to the sixth bit emission period BEM6, the row driver 130 may shift the bits stored in the second to seventh bit cells C2 to C7 and the feedback cell CFB to the first to seventh bit cells C1 to C7, respectively, by sequentially toggling the first to seventh shift register control signals CS_SR1 to CS_SR7. In this case, the first to seventh bit cells C1 to C7 may store the sixth to twelfth pixel driving bits D6 to D12, and the logic level of the PWM signal SPWM may be determined based on the sixth pixel driving bit D6 stored in the first bit cell C1. The row driver 130 may copy the sixth pixel driving bit D6 stored in the first bit cell C1 to the feedback cell CFB by toggling the eighth shift register control signal CS_SR8 after the data writing completion time point tDWC (e.g., after the feedback enable signal FB_EN transitions to logic high).

For a more concise explanation, FIG. 9 illustrates an embodiment in which the sixth pixel driving bit D6 is stored in the second bit cell C2 before the twenty-sixth time point t26, but the scope of the present disclosure is not limited thereto. For example, the row driver 130 may be implemented to sequentially toggle the first to seventh shift register control signals CS_SR1 to CS_SR7 before the twenty-sixth time point t26 and toggle only the eighth shift register control signal CS_SR8 during the sixth bit emission period BEM6.

The shift register SR may sequentially rotate the shift register SR one bit by one bit, during a time period between the twenty-seventh time point t27 and the twenty-eighth time point t28 corresponding to the seventh to twelfth bit emission periods BEM7 to BEM12. Accordingly, the logic level of the PWM signal SPWM of the seventh to twelfth bit emission periods BEM7 to BEM12 may be determined based on the seventh to twelfth pixel driving bits D7 to D12, respectively.

According to an embodiment, in response to the source selection signal SEL_SRC transitioning to logic high at the twenty-eighth time point t28, the source selection multiplexer MUX_SRC may determine the logic level of the PWM signal SPWM based on the thirteenth pixel driving bit D13.

According to an embodiment of FIG. 9, the display pixel PX may perform the data writing operation while performing the bit emission operation. In this case, unlike the embodiment described above with reference to FIG. 8, the column driver 120 may not output the pixel driving bits D before the first bit emission period BEM1. Accordingly, according to the embodiment of FIG. 9, the time length required from the driving beginning time point tDBGN to the end of the light emission period TEM (e.g., the time length between the driving beginning time point tDBGN and the twenty-ninth time point t29) may be reduced.

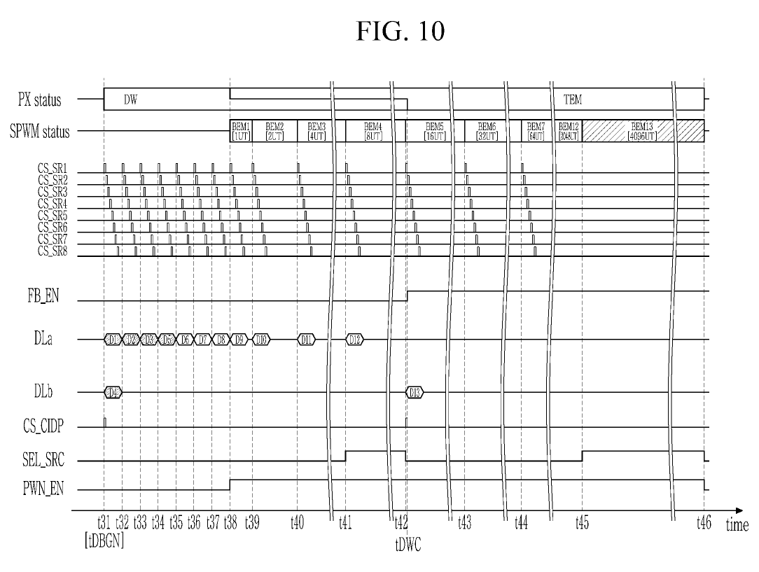

Next, referring to FIG. 10, the column driver 120 may output the first to third pixel driving bits D1 to D3 and the fourth to twelfth pixel driving bits D4 to D12 through the first data line DLa, and may output the fourth and thirteenth pixel driving bits D4 to D13 through the second data line DLb. In the following, for the sake of brevity, the differences from the driving method of the display pixel PX described above with reference to FIGS. 8 and 9 will be explained in detail.

The row driver 130 may set the feedback enable signal FB_EN to logic low during the data writing period DW. For example, the row driver 130 may set the feedback enable signal FB_EN to logic low between the thirty-first time point t31 (e.g., the driving beginning time point tDBGN) and the data writing completion time point tDWC. The row driver 130 may set the feedback enable signal FB_EN to logic high after the data writing period DW is completed. For example, the row driver 130 may set the feedback enable signal FB_EN to logic high between the data writing completion time point tDWC and the forty-sixth time point t46.

The row driver 130 may set the PWM enable signal PWM_EN to logic high during the light emission period TEM. For example, the row driver 130 may set the PWM enable signal PWM_EN to logic high between the thirty-eighth time point t38 and the forty-sixth time point t46.

The light emission period TEM may include first to thirteenth bit emission periods BEM1 to BEM13. The row driver 130 may set the source selection signal SEL_SRC to logic low between the thirty-eighth time point t38 and the forty-first time point t41 corresponding to the first to third bit emission periods BEM1 to BEM3; may set the source selection signal SEL_SRC to logic high between the forty-first time point t41 and the forty-second time point t42 corresponding to the fourth bit emission period BEM4; may set the source selection signal SEL_SRC to logic low between the forty-second time point t42 and the forty-fifth time point t45 corresponding to the fifth to twelfth bit emission periods BEM5 to BEM12; and may set the source selection signal SEL_SRC to logic high between the forty-fifth time point t45 and the forty-sixth time point t46 corresponding to the thirteenth bit emission period BEM13.

According to an embodiment, between the thirty-first time point t31 and the thirty-eighth time point t38, the column driver 120 may sequentially provide the first to third pixel driving bits D1 to D3 and the fifth to eighth pixel driving bits D5 to D8, to the first data line DLa. The row driver 130 may sequentially store the first to third pixel driving bits D1 to D3 and the fifth to eighth pixel driving bits D5 to D8 in the shift register SR by controlling the first to eighth shift register control signals CS_SR1 to CS_SR8. According to an embodiment, the manner in which the plurality of pixel driving bits D are stored in the shift register SR between the thirty-first time point t31 and the thirty-eighth time point t38 is similar to that described with reference to the time period between the first time point t1 and the eighth time point t8 of FIG. 8, and therefore, a detailed description thereof is omitted.

The column driver 120 may provide the eighth pixel driving bit D8 to the first data line DLa at the thirty-eighth time point t38, and the row driver 130 may sequentially toggle the first to eighth shift register control signals CS_SR1 to CS_SR8. In this case, the first to third pixel driving bits D1 to D3 and the fifth to ninth pixel driving bits D5 to D9 may be stored in the shift register SR; and as the first pixel driving bit D1 is stored in the first bit cell C1, the source selection multiplexer MUX_SRC may determine the logic level of the PWM signal SPWM during the first bit emission period BEM1 based on the first pixel driving bit D1.

During a time period between the thirty-ninth time point t39 and the forty-first time point t41 corresponding to the second and third bit emission periods BEM2 and BEM3, the shift register SR may delete the second and third pixel driving bits D2 and D3 and newly store the tenth and eleventh pixel driving bits D10 and D11. For example, based on the control of the row driver 130, the shift register SR may delete the second and third pixel driving bits D2 and D3 and newly store the tenth and eleventh pixel driving bits D10 and D11.

After the third bit emission period BEM3 ends, the twelfth pixel driving bit D12 may be newly written to the shift register SR. For example, after the forty-first time point t41, the column driver 120 may provide the twelfth pixel driving bit D12 to the first data line DLa. The row driver 130 may sequentially delete the third pixel driving bit D3 from the shift register SR and newly store the twelfth pixel driving bit D12 in the shift register SR by toggling the first to eighth shift register control signals CS_SR1 to CS_SR8. In this case, the fifth to eleventh pixel driving bits D5 to D11 may be stored in the first to seventh bit cells C1 to C7, respectively, and the twelfth pixel driving bit D12 may be stored in the feedback cell CFB.

The column driver 120 may provide the fourth pixel driving bit D4 to the second data line DLb before the forty-first time point t41 at which the fourth bit emission period BEM4 begins. For example, between the thirty-first time point t31 and the thirty-second time point t32, the column driver 120 may output the fourth pixel driving bit D4 to the second data line DLb and the row driver 130 may toggle the independent bit cell control signal CS_CIDP. In this case, the fourth pixel driving bit D4 may be stored in the independent bit cell CIDP. However, the scope of the present disclosure is not limited to the specific time point at which the fourth pixel driving bit D4 is written to the independent bit cell CIDP. For example, the fourth pixel driving bit D4 may be written to the independent bit cell CIDP at any time point between the driving beginning time point tDBGN and the forty-first time point t41.

During a time period between the forty-first time point t41 and the forty-second time point t42 corresponding to the fourth bit emission period BEM4, the source selection multiplexer MUX_SRC may determine the logic level of the PWM signal SPWM based on the output signal of the independent bit cell CIDP (e.g., the logic level corresponding to the fourth pixel driving bit D4).

After the forty-second time point t42 at which the fourth bit emission period BEM4 ends, the column driver 120 may provide the thirteenth pixel driving bit D13 to the second data line DLb. The row driver 130 may toggle the independent bit cell control signal CS_CIDP. In this case, the fourth pixel driving bit D4 may be deleted from the independent bit cell CIDP, and the thirteenth pixel driving bit D13 may be newly stored.

In an example case in which a pixel driving bit (e.g., the fifth pixel driving bit D5) that is deleted from the in-pixel memory IPM most recently (e.g., the last deleted bit) among the discard data D_DSCD is stored in the shift register SR, the column driver 120 may end the data writing operation for the display pixel PX even before a bit emission period (e.g., the fifth bit emission period BEM5) corresponding to the pixel driving bit that is deleted from the in-pixel memory IPM most recently (e.g., the last deleted bit) among the discard data D_DSCD ends. For example, the data writing completion time point tDWC may be a time point before the end of the fifth bit emission period BEM5.

In an example case in which a pixel driving bit (e.g., the fourth pixel driving bit D4) that is deleted from the in-pixel memory IPM in the second-to-last order among the discard data D_DSCD is stored in a different location (e.g., an independent bit cell CIDP) than the pixel driving bit (e.g., the fifth pixel driving bit D5) that is deleted from the in-pixel memory IPM most recently (e.g., the last deleted bit) among the discard data D_DSCD, the time required from a time point at which the bit emission period (e.g., the fourth bit emission period BEM4) corresponding to the pixel driving bit that is deleted from the in-pixel memory IPM in the second-to-last order among the discard data D_DSCD is completed to the data writing completion time point tDWC may be minimized. For example, the row driver 130 may complete the data writing operation for the display pixel PX by toggling only the independent bit cell control signal CS_CIDP from after a time point at which the fourth bit emission period BEM4 is completed (e.g., without toggling all of the first to eighth shift register control signals CS_SR1 to CS_SR8).

According to an embodiment, between the forty-second time point t42 and the forty-third time point t43 corresponding to the fifth bit emission period BEM5, the row driver 130 may move bits stored in the second to seventh bit cells C2 to C7 and the feedback cell CFB to the first to seventh bit cells C1 to C7, respectively, by sequentially toggling the first to seventh shift register control signals CS_SR1 to CS_SR7. In this case, the first to seventh bit cells C1 to C7 may store the sixth to twelfth pixel driving bits D6 to D12, respectively. The row driver 130 may copy the sixth pixel driving bit D6 stored in the first bit cell C1 to the feedback cell CFB by toggling the eighth shift register control signal CS_SR8 after the data writing completion time point tDWC (e.g., after the feedback enable signal FB_EN transitions to logic high).

The row driver 130 may sequentially rotate the shift register SR one bit by one bit, during a time period between the forty-third time point t43 and the forty-fifth time point t45 corresponding to the sixth to twelfth bit emission periods BEM6 to BEM12. In this way, the logic level of the PWM signal SPWM of the sixth to twelfth bit emission periods BEM6 to BEM12 may be determined based on the sixth to twelfth pixel driving bits D6 to D12, respectively.

According to an embodiment, in response to the source selection signal SEL_SRC transitioning to logic high at the forty-fifth time point t45, the source selection multiplexer MUX_SRC may determine the logic level of the PWM signal SPWM based on the thirteenth pixel driving bit D13.

According to an embodiment of FIG. 10, the total time length of that the column driver 120 provides pixel driving data PDD for the display pixel PX to the first and second data lines DLa and DLb may be reduced. In other words, according to the embodiment of FIG. 10, the time interval between the driving beginning time point tDBGN and the data writing completion time point tDWC may be reduced. For example, according to the embodiment described with reference to FIG. 8, the data writing completion time point tDWC may arrive after a time length required for all of the first to eighth shift register control signals CS_SR1 to CS_SR8 being sequentially toggled has elapsed from a time point at which the fourth bit emission period BEM4 is completed, and according to the embodiment of FIG. 10, the data writing completion time point tDWC may arrive after a time length required for toggling only the independent bit cell control signal CS_CIDP has elapsed from a time point at which the fourth bit emission period BEM4 is completed. For another example, according to the embodiment described with reference to FIG. 9, the data writing completion time point tDWC may arrive after the first to fifth bit emission periods BEM1 to BEM5 are completed, and according to the embodiment of FIG. 10, the data writing completion time point tDWC may arrive before the fifth bit emission period BEM5 begins. According to an embodiment of the present disclosure, a time length allocated to one display pixel PX for the first and second data lines DLa and DLb to provide the pixel driving data PDD may be reduced.

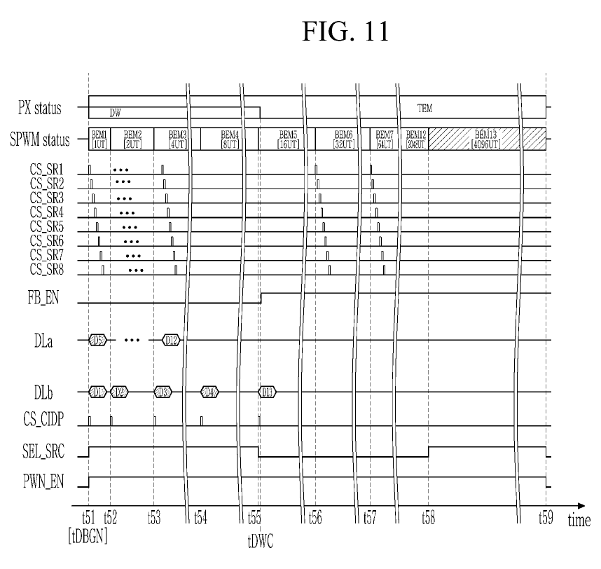

Next, referring to FIG. 11, the column driver 120 may output the fifth to twelfth pixel driving bits D5 to D12 through the first data line DLa, and may output the first to fourth pixel driving bits D1 to D4 and the thirteenth pixel driving bit D13 through the second data line DLb. In the following, for the sake of brevity, the differences from the driving method of the display pixel PX described above with reference to FIGS. 8-10 will be explained in detail.

The row driver 130 may set the feedback enable signal FB_EN to logic low during the data writing period DW. For example, the row driver 130 may set the feedback enable signal FB_EN to logic low between the fifty-first time point t51 (e.g., the driving beginning time point tDBGN) and the data writing completion time point tDWC. The row driver 130 may set the feedback enable signal FB_EN to logic high after the data writing period DW is completed. For example, the row driver 130 may set the feedback enable signal FB_EN to logic high between the data writing completion time point tDWC and the fifty-ninth time point t59.

The row driver 130 may set the PWM enable signal PWM_EN to logic high during the light emission period TEM. For example, the row driver 130 may set the PWM enable signal PWM_EN to logic high between the fifty-first time point t51 and the fifty-ninth time point t59.

The light emission period TEM may include first to thirteenth bit emission periods BEM1 to BEM13. The row driver 130 may set the source selection signal SEL_SRC to logic high between the fifty-first time point t51 and the fifty-fifth time point t55 corresponding to the first to fourth bit emission periods BEM1 to BEM4; may set the source selection signal SEL_SRC to logic low between the fifty-fifth time point t55 and the fifty-eighth time point t58 corresponding to the fifth to twelfth bit emission periods BEM5 to BEM12; and may set the source selection signal SEL_SRC to logic high between the fifty-eighth time point t58 and the fifty-ninth time point t59 corresponding to the thirteenth bit emission period BEM13.

The column driver 120 may sequentially provide the first to fourth pixel driving bits D1 to D4 to the second data line DLb. The display pixel PX may determine the logic level of the PWM signal SPWM during the first to fourth bit emission periods BEM1 to BEM4 based on the first to fourth pixel driving bits D1 to D4 based on the control of the row driver 130. The driving method of the display pixel PX between the fifty-first time point t51 and the fifty-fifth time point t55 is similar to the driving method of the display pixel PX between the twenty-first time point t21 and the twenty-fifth time point t25 described above with reference to FIG. 9, and therefore, a detailed description thereof is omitted.

The column driver 120 may provide the thirteenth pixel driving bit D13 to the second data line DLb before the fifty-eighth time point t58 at which the thirteenth bit emission period BEM13 begins. For example, the column driver 120 may output the thirteenth pixel driving bit D13 to the second data line DLb after the fifty-fifth time point t55, and the row driver 130 may toggle the independent bit cell control signal CS_CIDP. In this case, the thirteenth pixel driving bit D13 may be stored in the independent bit cell CIDP.

The column driver 120 may provide the fifth to twelfth pixel driving bits D5 to D12 to the first data line DLa before the fifty-fifth time point t55 at which the fifth bit emission period BEM5 begins. For example, the column driver 120 may sequentially provide the fifth to twelfth pixel driving bits D5 to D12 to the first data line DLa after the fifty-first time point t51, and the row driver 130 may store the fifth to twelfth pixel driving bits D5 to D12 in the shift register SR by controlling the first to eighth shift register control signals CS_SR1 to CS_SR8.

As the source selection signal SEL_SRC transitions to logic low at the fifty-fifth time point t55, the logic level of the PWM signal SPWM during the fifth bit emission period BEM5 may be determined based on the fifth pixel driving bit D5 stored in the first bit cell C1.

During the time period between the fifty-sixth time point t56 and the fifty-seventh time point t57 corresponding to the sixth bit emission period BEM6, the row driver 130 may sequentially move the bits stored in the second to seventh bit cells C2 to C7 and the feedback cell CFB to the first to seventh bit cells C1 to C7, respectively, by toggling the first to seventh shift register control signals CS_SR1 to CS_SR7. In this case, the first to seventh bit cells C1 to C7 may store the sixth to twelfth pixel driving bits D6 to D12, respectively, and the logic level of the PWM signal SPWM may be determined based on the sixth pixel driving bit D6 stored in the first bit cell C1. Thereafter, the row driver 130 may copy the sixth pixel driving bit D6 stored in the first bit cell C1 to the feedback cell CFB by toggling the eighth shift register control signal CS_SR8.

The row driver 130 may sequentially rotate the shift register SR during the time period between the fifty-seventh time point t57 and the fifty-eighth time point t58 corresponding to the seventh to twelfth bit emission periods BEM7 to BEM12. In this way, the logic level of the PWM signal SPWM of the seventh to twelfth bit emission periods BEM7 to BEM12 may be determined based on the seventh to twelfth pixel driving bits D7 to D12, respectively.

As the source selection signal SEL_SRC transitions to logic high at the fifty-eighth time point t58, the logic level of the PWM signal SPWM during the thirteenth bit emission period BEM13 may be determined based on the thirteenth pixel driving bit D13 stored in the independent bit cell CIDP.

According to the embodiment of FIG. 11, unlike what was previously described with reference to FIG. 10, the display pixel PX may start a data writing operation immediately at the driving beginning time point tDBGN. That is, the display pixel PX may perform a data writing operation while performing a bit emission operation. In this case, a time length during which the first and second data lines DLa and DLb are allocated to one display pixel PX may be minimized.

For a more concise explanation, FIGS. 8-11 illustrate that the row driver 130 toggles the first shift register control signal CS_SR1 or the independent bit cell control signal CS_CIDP when each bit emission period BEM begins, but the scope of the present disclosure is not limited thereto. For example, the row driver 130 may be implemented to toggle the first shift register control signal CS_SR1 or the independent bit cell control signal CS_CIDP immediately before each bit emission period BEM begins (e.g., so that the timing at which the first shift register control signal CS_SR1 or the independent bit cell control signal CS_CIDP transitions to logic low coincides with the timing at which the bit emission period BEM or the sub-bit emission period SUB_BEM begins).

For a more concise explanation, various methods for controlling display pixels PX are exemplarily described with reference to FIGS. 8-11, but the scope of the present disclosure is not limited thereto. For example, the row driver 130 and the column driver 120 may drive the display pixel PX in various ways not shown in FIGS. 8-11 based on that the display pixel PX has two data paths resepctively connected to two data lines DL and that these two data paths may be independently controlled by the source selection multiplexer MUX_SRC.

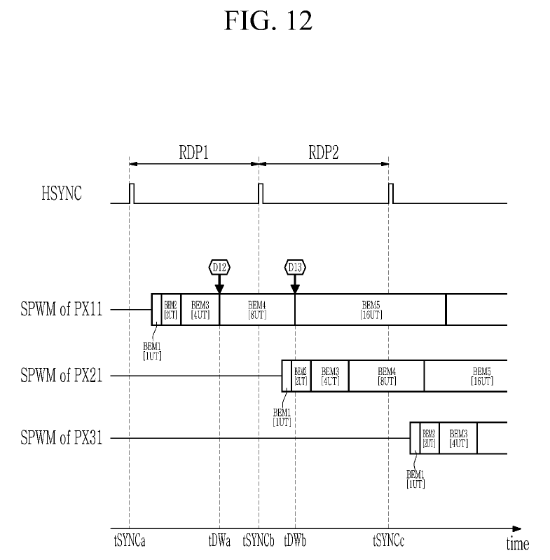

FIG. 12 is a diagram showing an effect in an example case in which the column driver is implemented to provide pixel driving bits read from external memory to the data line. Referring to FIGS. 1-12, a plurality of display pixels PX arranged in one display pixel column may share data lines DL. For example, each of the display pixels PX11 to PX13 may be connected to the first data line DLa and the second data line DLb. Accordingly, it may be impossible to simultaneously provide pixel driving bits D to the plurality of display pixels PX through a single set of data lines DL.

The timing control circuit 140 may generate a horizontal synchronization signal HSYNC. The timing control circuit 140 may control the operation timing of the column driver 120 and the row driver 130 based on the horizontal synchronization signal HSYNC. For example, the timing control circuit 140 may align time points at which the control over the display pixel rows begins based on time points at which the horizontal synchronization signal HSYNC toggles.

In an embodiment, the timing control circuit 140 may provide the horizontal synchronization signal HSYNC directly to the column driver 120 and the row driver 130. However, the scope of the present disclosure is not limited thereto.

In an embodiment, the timing control circuit 140 may receive the horizontal synchronization signal HSYNC from an external device. However, the scope of the present disclosure is not limited thereto.

For example, the column driver 120 and the row driver 130 may determine the time point at which to start controlling the plurality of display pixels PX arranged in one display pixel column based on the control of the timing control circuit 140. For example, the column driver 120 and the row driver 130 may start controlling the display pixel PX11 at a first synchronization point tSYNCa, start controlling the display pixel PX21 at a second synchronization point tSYNCb, and start controlling the display pixel PX31 at a third synchronization point tSYNCc based on the control of the timing control circuit 140.

In order to implement the column driver 120 in a smaller area, the column driver 120 may be implemented to process pixel driving data PDD provided from the timing control circuit 140 in a first-in-first-out manner. For example, the column driver 120 may not transmit pixel driving data PDD for the display pixel PX21 to the first and second data lines DLa and DLb until it transmits pixel driving data PDD for the display pixel PX11 to the first and second data lines DLa and DLb. Accordingly, the column driver 120 may need to provide pixel driving bits D for the display pixel PX11 to the first and second data lines DLa, DLb during the first row driving period RDP1 between the first synchronization point tSYNCa and the second synchronization point tSYNCb; and may need to provide pixel driving bits D for the display pixel PX21 to the first and second data lines DLa, DLb during the second row driving period RDP2 between the second synchronization point tSYNCb and the third synchronization point tSYNCc.

For example, the column driver 120 and the row driver 130 may be implemented to control a plurality of display pixels PX in the manner described above with reference to FIG. 10. In this case, after the first synchronization point tSYNCa, the column driver 120 may need to sequentially transmit each pixel driving bit D of the pixel driving data PDD for the display pixel PX11 to the first and second data lines DLa, DLb. For example, the column driver 120 may have to provide the twelfth pixel driving bit D12 to the first data line DLa at the first data writing time point tDWa at which the fourth bit emission period BEM4 begins; and the column driver 120 may have to provide the thirteenth pixel driving bit D13 to the second data line DLb at the second data writing time point tDWb at which the fifth bit emission period BEM5 begins.

The second data writing time point tDWb may be a time point after the second synchronization point tSYNCb. For example, the second data write time point tDWb may be a time point after the first row driving period RDP1. In this case, it may be impossible (e.g., prohibited) for the column driver 120 to transmit the thirteenth pixel driving bit D13 at the second data writing time point tDWb.

However, the column driver 120 may be implemented to separately receive the thirteenth pixel driving bit D13 from the out-pixel memory circuit 150. For example, the timing control circuit 140 may separate a timing at which the first to twelfth pixel driving bits D12 of the pixel driving data PDD for the display pixel PX11 are provided to the column driver 120, and a timing at which the thirteenth pixel driving bit D13 of the pixel driving data PDD for the display pixel PX11 is provided to the column driver 120. In this case, the column driver 120 may receive the thirteenth pixel driving bit D13 for the display pixel PX11 after the first row driving period RDP1, and may provide the thirteenth pixel driving bit D13 to the second data line DLb at the second data writing time point tDWb.

In this way, the column driver 120 may transmit buffer data D_BF provided from the out-pixel memory circuit 150 to the second data line DLb regardless of the row driving period RDP corresponding to the display pixel PX. For example, even in a case in which an interval between the horizontal synchronization signal HSYNC toggles is short, the column driver 120 may be able to successfully provide buffer data D_BF to the display pixels PX. In other words, in an example case in which the column driver 120 is implemented to receive a portion of the pixel driving data PDD as buffer data D_BF (e.g., from the out-pixel memory circuit 150), a timing margin for the column driver 120 to output the pixel driving data PDD may be secured.

For a more concise explanation, FIG. 12 is a representative example of an embodiment in which a column driver 120 and a row driver 130 control a plurality of display pixels PX in the manner previously described with reference to FIG. 10, but the scope of the present disclosure is not limited thereto. For example, the effects of the present disclosure may similarly occur in an example case in which a column driver 120 and a row driver 130 control a plurality of display pixels PX in the manners described above with reference to FIGS. 8-11.

In addition, although FIG. 12 illustrates an exemplary embodiment in which the column driver 120 is implemented to receive one pixel driving bit (e.g., the thirteenth pixel driving bit D13) as buffer data D_BF as pixel driving data PDD, the scope of the present disclosure is not limited thereto. For example, the column driver 120 may be implemented to receive the entire pixel driving data PDD as real-time data D_RLTM, or may be implemented to receive two or more pixel driving bits D as buffer data D_BF. That is, the scope of the present disclosure is not limited to the number of pixel driving bits included in the buffer data D_BF.

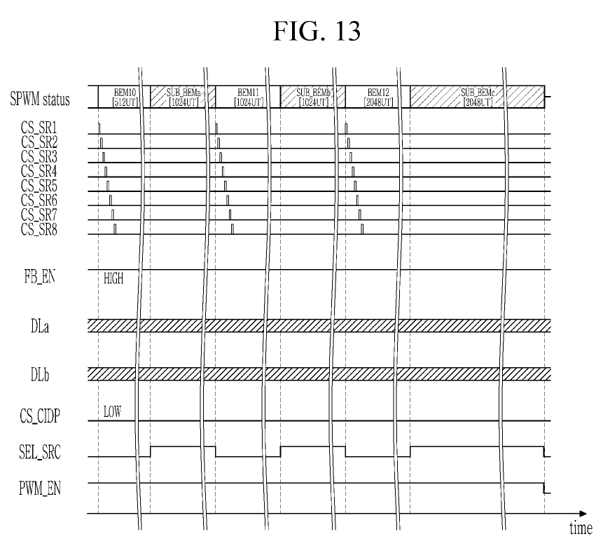

FIG. 13 is a timing diagram exemplarily showing a method of driving display pixels according to an embodiment. Referring to FIGS. 1-13, the row driver 130 may drive a bit emission period BEM corresponding to a pixel driving bit stored in the independent bit cell CIDP by dividing into two or more sub-bit emission periods SUB_BEM. For a more concise explanation, an embodiment in which the thirteenth bit emission period BEM13 includes a first sub-bit emission period SUB_BEMa, a second sub-bit emission period SUB_BEMb and a third sub-bit emission period SUB_BEMc is described below as a representative example. However, the disclosure is not limited thereto, and as such, a number of sub-bit emission period may be different than three.

The row driver 130 may determine an order of each of the first to third sub-bit emission periods SUB_BEMa to SUB_BEMc regardless of an order of other bit emission periods BEM. The row driver 130 may arrange the first to third sub-bit emission periods SUB_BEMa to SUB_BEMc so that they are not consecutive to each other. For example, the row driver 130 may arrange the first sub-bit emission period SUB_BEMa between the tenth and eleventh bit emission periods BEM10 and BEM11, arrange the second sub-bit emission period SUB_BEMb between the eleventh and twelfth bit emission periods BEM11 and BEM12, and arrange the third sub-bit emission period SUB_BEMc after the twelfth bit emission period BEM12.

For a more detailed example, the row driver 130 may change the output signal of the shift register SR by sequentially toggling the first to eighth shift register control signals CS_SR1 to CS_SR8 in each of the tenth bit emission period BEM10 to the twelfth bit emission period BEM12. The row driver 130 may determine the logic level of the PWM signal SPWM based on the thirteenth pixel driving bit D13 stored in the independent bit cell CIDP by setting the source selection signal SEL_SRC to logic high in each of the first to third sub-bit emission periods SUB_BEMa to SUB_BEMc.

In an embodiment, the lengths of each of the first to third sub-bit emission periods SUB_BEMa to SUB_BEMc may be the same or different. For example, the lengths of the first to third sub-bit emission periods SUB_BEMa to SUB_BEMc may be ‘1024UT’, ‘1024UT’, and ‘2048UT’, respectively. However, the scope of the present disclosure is not limited thereto.

According to an embodiment illustrated in FIG. 13, technical problems arising from the length of the bit emission period BEM corresponding to the pixel driving bit stored in the independent bit cell CIDP may be minimized. For example, in a case in which the MSB of the pixel driving data PDD is stored in an independent bit cell CIDP, problems arising due to the length of the bit emission period BEM corresponding to the MSB of the pixel driving data PDD may be minimized. In an example case in which the thirteenth bit emission period BEM13 is divided into a plurality of sub-bit emission periods SUB_BEM, a time during which the display pixels PX continuously emit light based on the thirteenth pixel driving bit D13 may be minimized, so that the false contour effect may be minimized. Therefore, the display device 100 according to the embodiment of the present disclosure may be able to generate a higher quality image.

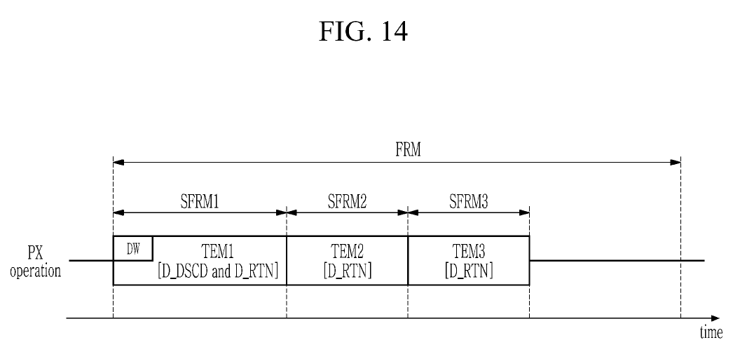

FIG. 14 is a timing diagram showing a frame period according to an embodiment. Referring to FIGS. 1-14, one frame period FRM may include one or more sub-frame periods SFRM. For example, one frame period FRM may include a first sub-frame period SFRM1, a second sub-frame periods SFRM2, and a third sub-frame period SFRM3. However, the scope of the present disclosure is not limited thereto, and one frame period FRM may include only one sub-frame period SFRM.

In an embodiment, a display pixel PXs may operate based on different pixel driving data PDD in different frame periods FRMs. Accordingly, the waveforms of the PWM signal SPWM of different frame periods FRM may be different. However, the scope of the present disclosure is not limited thereto.

According to an embodiment, in an example case in which one frame period FRM includes a plurality of sub-frame periods SFRM, instead of one pixel driving data PDD being used to determine the logic level of a PWM signal SPWM during one light emission period TEM having a relatively long length, one pixel driving data PDD may be used to determine the logic level of a PWM signal SPWM during a plurality of light emission periods TEM having a relatively short length. In this case, the ‘1UT’ length for each light emission period TEM may be minimized, so the false contour effect may be minimized. However, the scope of the present disclosure is not limited thereto. For example, the plurality of light emission periods TEM may include a first light emission period TEM1, a second light emission period TEM2 and a third light emission period TEM3.

The first to third sub-frame periods SFRM1 to SFRM3 may share one pixel driving data PDD. The first to third sub-frame periods SFRM1 to SFRM3 may include the first to third light emission periods TEM1 to TEM3, respectively. In the first to third light emission periods TEM1 to TEM3, a display pixel PX may perform light emission operations based on one pixel driving data PDD. For example, the display pixel PX may repeatedly use the retention data D_RTN received in the data writing period DW in the first to third sub-frame periods SFRM1 to SFRM3. In this case, since the display pixel PX may perform a light emission operation even in an example case in which the column driver 120 and the row driver 130 do not newly store pixel driving data PDD in the display pixel PX, the power consumption of the display device 100 may be minimized.

According to an embodiment, the row driver 130 and the column driver 120 may drive the display pixels PX in the manner previously described with reference to FIGS. 8-11 during the first sub-frame period SFRM1. However, for a more concise explanation below, it may be assumed that the row driver 130 and the column driver 120 drive the display pixels PX in the manner previously described with reference to FIG. 9 during the first sub-frame period SFRM1. For example, below, it may be assumed that the data writing period DW is included in the first light emission period TEM1. However, the scope of the present disclosure is not limited thereto. For example, the data writing period DW of the first sub-frame period SFRM1 may not overlap with the first light emission period TEM1.

During the first light emission period TEM1, the display pixel PX may perform a light emission operation based on both discard data D_DSCD and retention data D_RTN. For example, the first light emission period TEM1 may include the first to fifth bit emission periods BEM1 to BEM5 corresponding to discard data D_DSCD and the sixth to thirteenth bit emission periods BEM6 to BEM13 corresponding to retention data D_RTN.

During the first light emission period TEM1, the discard data D_DSCD may be deleted from the in-pixel memory IPM. For example, the row driver 130 and the column driver 120 may delete the discard data D_DSCD from the in-pixel memory IPM and write the retention data D_RTN to the in-pixel memory IPM during the first light emission period TEM1. Accordingly, only the retention data D_RTN may be stored in the in-pixel memory IPM at the end of the first sub-frame period SFRM1. In other words, the discard data D_DSCD may be lost from the in-pixel memory IPM at the end of the first sub-frame period SFRM1.

The time length of the first light emission period TEM1 may be longer than a toggle interval of the horizontal synchronization signal HSYNC described above with reference to FIG. 12. Accordingly, it may be difficult for the column driver 120 to provide new pixel driving bits to the display pixels PX after the first sub-frame period SFRM1 ends.

Accordingly, during the second light emission period TEM2 and the third light emission period TEM3, the display pixel PX may only perform emission operation for the retention data D_RTN. For example, each of the second light emission period TEM2 and the third light emission period TEM3 may include the sixth to thirteenth bit emission periods BEM6 to BEM13 and may not include the first to fifth bit emission periods BEM1 to BEM5.

In an embodiment, the time length of the first light emission period TEM1 may be longer than the time lengths of the second light emission period TEM2 and the third light emission period TEM3.

In an embodiment, the waveforms of the PWM signal SPWM during the second light emission period TEM2 and the third light emission period TEM3 may be identical to each other. However, the scope of the present disclosure is not limited thereto, and the duty ratios of the PWM signals SPWM of the second light emission period TEM2 and the third light emission period TEM3 may be the same, but the waveforms of the PWM signals SPWM may be different.

That is, according to the embodiment of FIG. 14, in an example case in which a plurality of sub-frame periods SFRM are included in one frame period FRM, the display pixels PX in the remaining sub-frame periods SFRM except for the first sub-frame period SFRM1 may operate with a relatively low luminance resolution.

In an embodiment, the discard data D_DSCD may be implemented as the lower bits of the pixel driving data PDD. In this case, the luminance resolution degradation of the display pixel PX during the sub-frame periods SFRM, at which the discard data D_DSCD being lost, may be minimized.

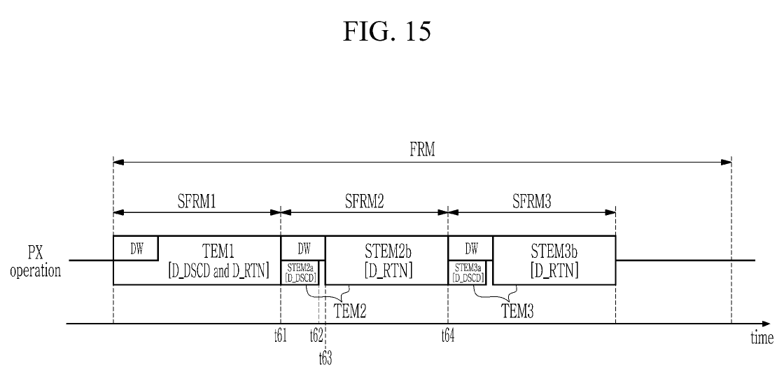

FIG. 15 is a timing diagram showing a frame period according to an embodiment. In the following, with reference to FIGS. 1 to 15, the differences from the frame period FRM described with reference to FIG. 14 are explained in detail.

A single frame period FRM may include one or more sub-frame periods SFRM. For example, one frame period FRM may include first to third sub-frame periods SFRM1 to SFRM3. The first to third sub-frame periods SFRM1 to SFRM3 may share one pixel driving data PDD. The first to third sub-frame periods SFRM1 to SFRM3 may include the first to third light emission periods TEM1 to TEM3, respectively.

During the first sub-frame period SFRM1, the row driver 130 and the column driver 120 may control the display pixels PX in a similar manner as described above with reference to FIG. 14.

The second light emission period TEM2 may include a first sub-light emission period STEM2a and a second sub-light emission period STEM2b. The third light emission period TEM3 may include a first sub-light emission period STEM3a and a second sub-light emission period STEM3b.

During the first sub-light emission periods STEM2a and STEM3a, the display pixel PX may perform a light emitting operation based on the discard data D_DSCD. During the second sub-light emission periods STEM2b and STEM3b, the display pixel PX may perform a light emitting operation based on the retention data D_RTN.

According to an embodiment, between the sixty-first time point t61 and the sixty-second time point t62, the row driver 130 and the column driver 120 may control the display pixel PX to perform a light emission operation based on the discard data D_DSCD. For example, similarly the description with reference to the time period between the twenty-first time point t21 and the twenty-sixth time point t26 of FIG. 9 above, the column driver 120 may sequentially provide one or more pixel driving bits D included in the discard data D_DSCD to the second data line DLb; and the display pixel PX may determine the logic level of the PWM signal SPWM based on the voltage level of the second data line DLb based on the control of the row driver 130. In this case, at the sixty-second time point t62 when the first sub-light emission periods STEM2a are completed, one pixel driving bit (e.g., the fifth pixel driving bit D5) included in the discard data D_DSCD may be stored in the independent bit cell CIDP.

According to an embodiment, between the sixty-second time point t62 and the sixty-third time point t63, the row driver 130 and the column driver 120 may update the independent bit cell CIDP based on the retention data D_RTN. For example, the column driver 120 may provide the thirteenth pixel driving bit D13 to the second data line DLb, and the row driver 130 may store the thirteenth pixel driving bit D13 in the independent bit cell CIDP by toggling the independent bit cell control signal CS_CIDP.

Thereafter, between the sixty-third time point t63 and the sixty-fourth time point t64, the display pixel PX may perform a light emission operation based on the retention data D_RTN stored in the in-pixel memory IPM based on the control of the row driver 130.

According to an embodiment of FIG. 15, during each sub-frame period SFRM, the display pixel PX may perform a light emission operation based on one or more pixel driving bits included in the discard data D_DSCD. In this case, the display pixels PX may also operate at a relatively high luminance resolution in the remaining sub-frame periods SFRM except the first sub-frame period SFRM1.

In an embodiment, the column driver 120 may control the second data line DLb between the sixty-first time point t61 and the sixty-third time point t63 based on pixel driving bits D provided from the out-pixel memory circuit 150. Accordingly, a number of bit emission periods BEM included in the first sub-light emission period STEM2a may be determined based on a number of bits of the buffer data D_BF (and further, a capacity of the out-pixel memory circuit 150). For example, in order for the first to fifth bit emission periods BEM1 to BEM5 to be included in the first sub-light emission period STEM2a, the buffer data D_BF may need to include the first to fifth pixel driving bits D1 to D5 to be provided through the second data line DLb between the sixty-first time point t61 and the sixty-second time point t62 and the sixth pixel driving bit D6 to be provided as the second data line DLb between the sixty-second time point t62 and the sixty-third time point t63. For another example, in order for the first sub-light emission period STEM2a to include only the fifth bit emission period BEM5, the buffer data D_BF may need to include the fifth pixel driving bit D5 to be provided through the second data line DLb between the sixty-first time point t61 and the sixty-second time point t62, and the thirteenth pixel driving bit D13 to be provided as the second data line DLb between the sixty-second time point t62 and the sixty-third time point t63. In other words, as the out-pixel memory circuit 150 stores a larger capacity of buffer data D_BF for each pixel driving data PDD, the display pixels PX may operate at a relatively higher luminance resolution in the remaining sub-frame periods SFRM except the first sub-frame period SFRM1.

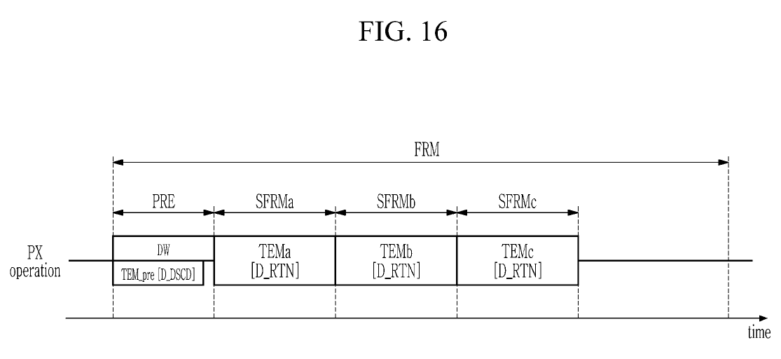

FIG. 16 is a timing diagram showing a frame period according to an embodiment. Referring to FIGS. 1-13 and 16, one frame period FRM may include one or more sub-frame periods SFRM. For example, one frame period FRM may include a prior control period PRE and a plurality of sub-frame periods. For example, the plurality of sub-frame periods may include a first sub-frame SFRMa, a second sub-frame SFRMb and a third sub-frame SFRMc. During the prior control period PRE and the first to third sub-frame periods SFRMa to SFRMc, the display pixel PX may operate based on one pixel driving data PDD. According to an embodiment, the prior control period PRE may be referred to as a preliminary control period or an initial control period.

During a prior control period PRE, the display pixel PX may perform a light emission operation based on the discard data D_DSCD. For example, the prior control period PRE may include a prior light emission period TEM_pre for the discard data D_DSCD. According to an embodiment, the prior light emission period TEM_pre may be referred to as a preliminary light emission period or an initial light emission period.

During the first to third sub-frame periods SFRMa to SFRMc, the display pixel PX may perform light emission operations based on the retention data D_RTN. For example, the first to third sub-frame periods SFRMa to SFRMc may include the first to third emission periods TEMa to TEMc for the retention data D_RTN, respectively.

During the prior light emission period TEM_pre, the row driver 130 and the column driver 120 may sequentially provide each of a plurality of pixel driving bits D included in the discard data D_DSCD to the second data line DLb; and the display pixel PX may determine the logic level of the PWM signal SPWM based on the voltage level of the second data line DLb based on the control of the row driver 130. That is, the row driver 130 and the column driver 120 may drive the display pixel PX in the manner described above with reference to the time period between the twenty-first time point t21 and the twenty-sixth time point t26 of FIG. 9. However, the scope of the present disclosure is not limited thereto, and the row driver 130 and the column driver 120 may also drive the display pixels PX in the manner described above with reference to the time period between the first time point t1 and the thirteenth time point t13 of FIG. 8.

The row driver 130 and the column driver 120 may determine the length of the prior light emission period TEM_pre based on a code length of the discard data D_DSCD and a number of sub-frame periods SFRM included in the frame period FRM. In an example case in which the discard data D_DSCD includes the first to fifth pixel driving bits D1 to D5, the row driver 130 and the column driver 120 may determine a length of the prior light emission period TEM_pre as a product of a sum (e.g., 31UT) of the first to fifth bit emission periods BEM1 to BEM5 described above and a number of sub-frame periods SFRM included in the frame period FRM (e.g., 3). For example, even a case in which the display pixel PX performs a light emission operation based solely on the retention data D_RTN during the plurality of sub-frame periods SFRM, the display pixel PX may operate with a high luminance resolution because the display pixel PX performs a light emission operation corresponding to the discard data D_DSCD during the prior control period PRE.

After the prior light emission period TEM_pre is completed, the row driver 130 and the column driver 120 may store the retention data D_RTN in the in-pixel memory IPM. For example, the row driver 130 and the column driver 120 may store the thirteenth pixel driving bit D13 in the independent bit cell CIDP.

For a more concise explanation, FIG. 16 is a representative example in which discard data D_DSCD includes lower bits of pixel driving data PDD and the display pixel PX performs a light emission operation corresponding to the discard data D_DSCD during the prior light emission period TEM_pre, but the scope of the present disclosure is not limited thereto. For example, the discard data D_DSCD may include upper bits of the pixel driving data PDD. In this case, the length of the prior light emission period TEM_pre may be longer than a length of each sub-frame period SFRM.

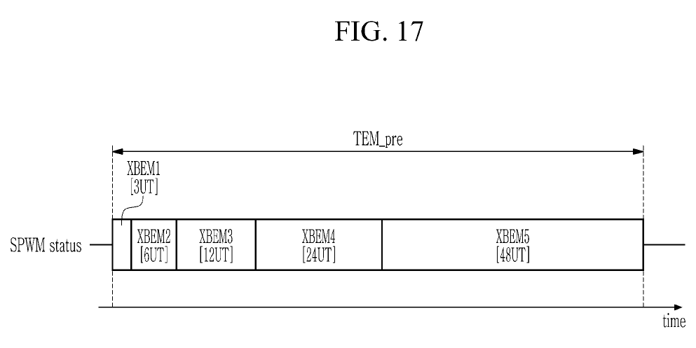

FIG. 17 is a diagram showing a state of the PWM signal during the prior light emission period of FIG. 16 according to an embodiment. Referring to FIGS. 1-13 and FIGS. 16-17, the prior light emission period TEM_pre may include a plurality of extended bit emission periods XBEM for the discard data D_DSCD. For example, the prior light emission period TEM_pre may include first to fifth extended bit emission periods XBEM1 to XBEM5 corresponding to the first to fifth pixel driving bits D1 to D5, respectively. For example, the prior light emission period TEM_pre may include a first extended bit emission period XBEM1 corresponding the first pixel driving bit D1, a second extended bit emission period XBEM2 corresponding the second pixel driving bit D2, a third extended bit emission period XBEM3 corresponding the third pixel driving bit D3, a fourth extended bit emission period XBEM4 corresponding the fourth pixel driving bit D4, and a fifth extended bit emission period XBEM5 corresponding the fourth pixel driving bit D5.

The length of the first to fifth extended bit emission periods XBEM1 to XBEM5 may correspond to values obtained by multiplying the length of the first to fifth bit emission periods BEM1 to BEM5 by a number of sub-frame periods SFRM included in one frame period FRM. For example, the length of the first extended bit emission period XBEM1 may be ‘3UT’, which is the product of a length of the first bit emission period BEM1 and a number of sub-frame periods SFRM included in one frame period FRM; and the length of the second extended bit emission period XBEM2 may be ‘6UT’, which is the product of the length of the second bit emission period BEM2 and the number of sub-frame periods SFRM included in one frame period FRM.

In this way, instead of performing a light emission operation based solely on the retention data D_RTN during the light emission period TEM of each sub-frame period SFRM, the display pixel PX may perform a bit emission operation for the discard data D_DSCD to be performed for the plurality of sub-frame periods SFRM in advance during the prior light emission period TEM_pre. In other words, the row driver 130 may determine a total time length that the display pixel PX is turned on during the prior light emission period TEM_pre, based on a number of sub-frame periods SFRM included in the frame period FRM. In this case, the display pixels PX may be able to operate with higher luminance resolution.

For a more concise explanation, FIG. 17 is representatively described as an embodiment in which the prior light emission period TEM_pre includes a plurality of extended bit emission periods XBEM, which are respectively corresponding to pixel driving bits D included in the discard data D_DSCD, but the scope of the present disclosure is not limited thereto. For example, the prior light emission period TEM_pre may be implemented to include a plurality of bit emission periods BEM per each pixel driving bit D included in the discard data D_DSCD. For a more detailed example, the prior light emission period TEM_pre may include three for each of the first to fifth bit emission periods BEM1 to BEM5.

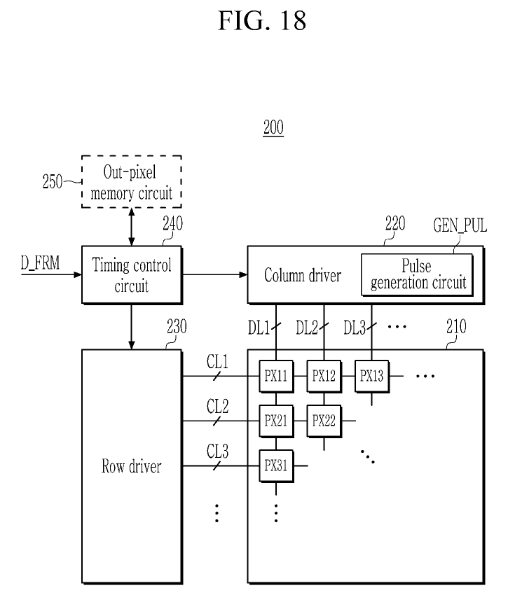

FIG. 18 is a block diagram showing a display device according to an embodiment of the present disclosure. Referring to FIGS. 1-18, a display device 200 may include a display pixel array 210, a column driver 220, a row driver 230, a timing control circuit 240, and an out-pixel memory circuit 250. The configuration and function of the display pixel array 210, row driver 230, timing control circuit 240, and out-pixel memory circuit 250 are similar to the configuration and function of the display pixel array 110, row driver 130, timing control circuit 140, and out-pixel memory circuit 150 described above with reference to FIGS. 1-17, and therefore, a detailed description thereof is omitted.

The column driver 220 may include a pulse generation circuit GEN_PUL. The pulse generation circuit GEN_PUL may generate a pixel driving pulse (hereinafter referred to as “PUL”) having a pulse width corresponding to one or more pixel driving bits D included in the pixel driving data PDD. For example, instead of sequentially providing one or more pixel driving bits D to the second data line DLb, the column driver 220 may provide the pixel driving pulse PUL to the second data line DLb.

The display pixel PX may generate a PWM signal SPWM based on the pixel driving pulse PUL and perform the light emission operation based on the PWM signal SPWM.

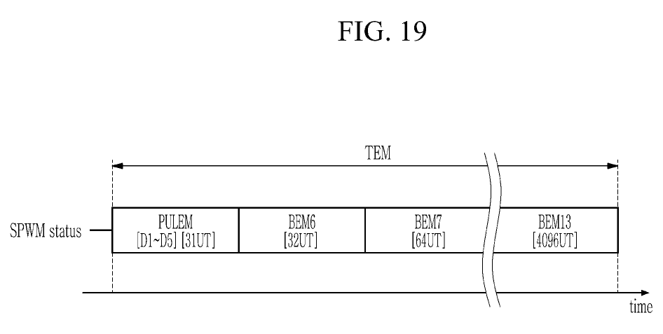

FIG. 19 is a drawing showing in more detail the configuration of a PWM signal according to the embodiment of FIG. 18. Referring to FIGS. 1-19, the light emission period TEM may include a pulse emission period PULEM and a plurality of bit emission periods BEM.

The display pixel PX may determine a logic level of the PWM signal SPWM based on the pixel driving pulse PUL during the pulse emission period PULEM.

The column driver 120 may generate the pixel driving pulse PUL based on the discard data D_DSCD. For example, the column driver 120 may determine the pulse width of the pixel driving pulse PUL based on values indicated by the pixel driving bits D included in the discard data D_DSCD.

That is, the column driver 120 may provide the pixel driving pulse PUL instead of the discard data D_DSCD to the second data line DLb. The display pixel PX may perform a light emission operation based on the pixel driving pulse PUL instead of the discard data D_DSCD. In this case, as the pulse generation circuit GEN_PUL is implemented to adjust a pulse width of the pixel driving pulse PUL more finely , the display pixel PX may be able to operate with a high luminance resolution even in an example case in which a small number of pixel driving bits are stored in the in-pixel memory IPM. For example, as the pulse generation circuit GEN_PUL operates based on a higher frequency clock, the pulse generation circuit GEN_PUL is implemented to adjust the pulse width of the pixel driving pulse PUL in units shorter than ‘1UT’).

In an embodiment, the time length of the pulse emission period PULEM may correspond to a sum of the lengths of the bit emission periods BEM corresponding to the discard data D_DSCD. For example, the time length of the pulse emission period PULEM may be ‘31UT’, which is the sum of the first to fifth bit emission periods BEM1 to BEM5. However, the scope of the present disclosure is not limited thereto. For example, one frame period FRM may include a plurality of sub-frame periods SFRM. In this case, similar to what was previously described with reference to FIG. 16, the pulse generation circuit GEN_PUL may also determine the pulse width WD_PUL based on a number of sub-frame periods SFRM included in the frame period FRM.

The display pixel PX may perform a light emission operation based on the retention data D_RTN during a plurality of bit emission periods BEM. For example, the display pixel PX may perform a light emission operation in a manner similar to that described above with reference to FIGS. 8-11 during the sixth to thirteenth bit emission periods BEM6 to BEM13.

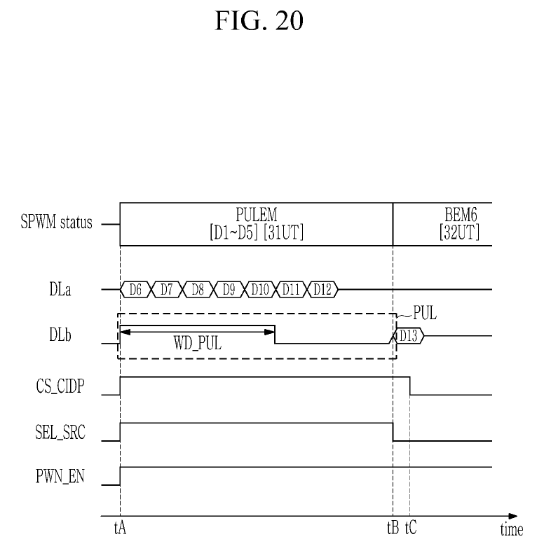

FIG. 20 is a timing diagram showing a driving method of a display pixel according to the embodiment of FIG. 19. Referring to FIGS. 1-20, the column driver 120 may provide the pixel driving pulse PUL to the second data line DLb during a time period between a first time point tA and a second time point tB corresponding to the pulse emission period PULEM. In this case, the pulse generation circuit GEN_PUL may obtain or generate a pulse width WD_PUL of the pixel driving pulse PUL based on the pixel driving bits. For example, the pulse generation circuit GEN_PUL may determine a pulse width WD_PUL of the pixel driving pulse PUL based on the values indicated by the first to fifth pixel driving bits D1 to D5. In an example case in which the discard data D_DSCD is ‘11010’ (e.g., when the first to fifth pixel driving bits D1 to D5 are ‘1’, ‘1’, ‘0’, ‘1’, and ‘1’, respectively), the pulse generation circuit GEN_PUL may determine the pulse width WD_PUL as 26UT (e.g., 1×2⁴ + 1×2³ + 0×2² + 1×2¹ + 0×2⁰ UT), which is a length corresponding to the value of the discard data D_DSCD. However, the scope of the present disclosure is not limited thereto.

For a more concise explanation, FIG. 20 is representatively described as an embodiment in which a pixel driving pulse PUL transitions to logic high at the first time point tA and transitions to logic low at a time point after a time corresponding to the pulse width WD_PUL has elapsed from the first time point tA, but the scope of the present disclosure is not limited thereto. For example, the pixel driving pulse PUL may be implemented to toggle more than twice between the first time point tA and the second time point tB (e.g., to divide the pulse width WD_PUL into two or more time periods).

The row driver 130 may maintain the PWM enable signal PWM_EN, the source selection signal SEL_SRC, and the independent bit cell control signal CS_CIDP at logic high during the pulse emission period PULEM. In this case, the logic level of the PWM signal SPWM may be determined based on the voltage level of the second data line DLb (e.g., the logic level of the pixel driving pulse PUL).

The column driver 220 may provide at least a portion of the retention data D_RTN (e.g., pixel driving bits D to be stored in the shift register SR) to the first data line DLa during the pulse emission period PULEM. The row driver 130 may store at least some of the retention data D_RTN in the shift register SR, by sequentially controlling the first to eighth shift register control signals CS_SR1 to CS_SR8. For example, the row driver 130 and the column driver 120 may store the sixth to twelfth pixel driving bits D6 to D12 in the shift register SR before the second time point tB. In this case, the display pixel PX may perform a light emission operation even in an example case in which the pixel driving bit is not stored in the in-pixel memory IPM before the sixth bit emission period BEM6 begins and after the pulse emission period PULEM is completed. However, the scope of the present disclosure is not limited thereto, and the row driver 130 and the column driver 120 may control the display pixel PX to store the sixth to twelfth pixel driving bits D6 to D12 before the first time point tA, or may control the display pixel PX to store the sixth to twelfth pixel driving bits D6 to D12 before the sixth bit emission period BEM6 starts and after the pulse emission period PULEM is completed.

After the second time point tB, the column driver 120 may provide some of the retention data D_RTN (e.g., pixel driving bits to be stored in the independent bit cell CIDP) to the second data line DLb. For example, the column driver 120 may provide the thirteenth pixel driving bit D13 to the second data line DLb. The row driver 130 may set the independent bit cell control signal CS_CIDP to logic high between the second time point tB and the third time point tC. In this case, the thirteenth pixel driving bit D13 may be stored in an independent bit cell CIDP. That is, the row driver 130 and the column driver 120 may store the thirteenth pixel driving bit D13 in the independent bit cell CIDP in the sixth bit emission period BEM6. In this case, the display pixel PX may perform a light emission operation even in an example case in which the pixel driving bit is not stored in the in-pixel memory IPM before the sixth bit emission period BEM6 starts and after the pulse emission period PULEM is completed. However, the scope of the present disclosure is not limited thereto, and the row driver 130 and the column driver 120 may also control the display pixel PX to perform a light emission operation corresponding to the sixth pixel driving bit D6 after the third time point tC at which the thirteenth pixel driving bit D13 is stored in the independent bit cell CIDP.

The above-described contents are specific embodiments for carrying out the present disclosure. However, the scope of the present disclosure is not limited thereto and should be determined based on the claims set forth below and their equivalents.

What is claimed is:

1. A display device comprising:
a column driver configured to:
receive first pixel driving data comprising a plurality of pixel driving bits, and
control a first data line and a second data line based on the first pixel driving data;
a first display pixel comprising an in-pixel memory and connected to the first data line and the second data line; and
a row driver configured to control an operation of the first display pixel,
wherein the first display pixel is configured to write one or more pixel driving bits among the plurality of pixel driving bits into the in-pixel memory during a first time period during which the first display pixel performs a first light emission operation corresponding to the first pixel driving data.

2. The display device of claim 1, further comprising an out-pixel memory circuit storing a first pixel driving bit among the one or more pixel driving bits,
wherein the column driver is configured to control the second data line based on the first pixel driving bit provided from the out-pixel memory circuit, during a second time period included in the first time period.

3. The display device of claim 2, further comprising a second display pixel connected to the first data line and the second data line,
wherein the column driver is further configured to:
receive a second pixel driving data corresponding to a same frame period as the first pixel driving data; and
control the first data line and the second data line based on the second pixel driving data, and
wherein the second time period is a time period after which the column driver is configured to start providing the second pixel driving data to the first data line or the second data line.

4. The display device of claim 2, wherein the first pixel driving bit is a most significant bit (MSB) for the first pixel driving data.

5. The display device of claim 1, wherein:
the first display pixel further comprises:
a source selection multiplexer configured to generate a pulse width modulation (PWM) signal; and
a light emission circuit configured to operate based on the PWM signal,
the in-pixel memory comprises:
a shift register connected between a first input terminal of the source selection multiplexer and the first data line; and
an independent bit cell connected between a second input terminal of the source selection multiplexer and the second data line.

6. The display device of claim 5, wherein a capacity of the first pixel driving data is greater than a capacity of the in-pixel memory.

7. The display device of claim 6, wherein the first pixel driving data comprises:
discard data comprising a first plurality of pixel driving bits corresponding to a first subset of the plurality of pixel driving bits; and
retention data comprising a second plurality of pixel driving bits corresponding to a second subset of the plurality of pixel driving bits, and
wherein the first display pixel is configured to delete the discard data from the in-pixel memory by an end time point of the first time period.

8. The display device of claim 7, wherein:
the first pixel driving data is implemented with n pixel driving bits (where n is an integer greater than or equal to 2),
the first plurality of pixel driving bits corresponds to lower m pixel driving bits of the first pixel driving data, and (wherein m is an integer greater than or equal to 1), and
the second plurality of pixel driving bits corresponds to upper (n-m) pixel driving bits of the first pixel driving data.

9. The display device of claim 7, wherein the column driver is further configured to:
provide a second pixel driving bit, which is most recently deleted from the in-pixel memory among the first plurality of pixel driving bits, to the first data line.

10. The display device of claim 9, wherein the column driver is further configured to:
provide a third pixel driving bit, which is pixel driving bit deleted from the in-pixel memory in second-to-last order among the first plurality of pixel driving bits, to the second data line.

11. The display device of claim 6, wherein:
the first pixel driving data comprises:
discard data comprising a first plurality of pixel driving bits corresponding to a first subset of the plurality of pixel driving bits; and
retention data comprising a second plurality of pixel driving bits corresponding to a second subset of the plurality of pixel driving bits, and
the column driver is configured to:
generate a pixel driving pulse based on the discard data; and
provide the pixel driving pulse to the second data line.

12. The display device of claim 11, wherein:
the column driver is configured to provide the pixel driving pulse to the second data line during a third time period anteceding the first time period; and
the first display pixel is configured to perform a second light emission operation based on a voltage level of the second data line during the third time period.

13. A display device comprising:
a column driver configured to control one or more data lines based on first pixel driving data, the first pixel driving data comprising discard data having a first code length and retention data having a second code length;
a display pixel connected to one or more of the one or more data lines and comprising an in-pixel memory having a capacity corresponding to the second code length; and
a row driver configured to control the display pixel to perform a first light emission operation based on the discard data during a first time period, and control the display pixel to perform a second light emission operation based on the retention data during a second time period after the first time period,
wherein the in-pixel memory is configured to store the retention data during the second time period.

14. The display device of claim 13, wherein:
the row driver is further configured to control the display pixel to perform a third light emission operation based on the retention data during a third time period after the second time period; and
a first total time length during which the display pixel is turned on during the second time period is same as a second total time length during which the display pixel is turned on during the third time period.

15. The display device of claim 14, wherein:
the first time period, the second time period and the third time period are included in a first frame period, and
the row driver is further configured to determine a third total time length during which the display pixel is turned on during the first time period, based on a number of sub-frames included in the first frame period and the discard data.

16. The display device of claim 14, further comprising an out-pixel memory circuit configured to store a first pixel driving bit included in the discard data and a second pixel driving bit included in the retention data,
wherein the column driver is further configured to:
provide the first pixel driving bit to the one or more data lines during a fourth time period between the second time period and the third time period, and
provide the second pixel driving bit to the one or more data lines during a fifth time period between the fourth time period and the third time period, and
wherein the row driver is further configured to:
control the display pixel to perform a fourth light emission operation based on the first pixel driving bit during the fourth time period, and
control the display pixel to update the in-pixel memory based on the second pixel driving bit during the fifth time period.

17. The display device of claim 13, wherein:
the display pixel further comprises:
a source selection multiplexer configured to generate a pulse width modulation (PWM) signal; and
a light emission circuit configured to operate based on the PWM signal,
the one or more data lines include a first data line and a second data line, and
the in-pixel memory comprises:
a shift register connected between a first input terminal of the source selection multiplexer and the first data line; and
an independent bit cell connected between a second input terminal of the source selection multiplexer and the second data line.

18. The display device of claim 17, wherein:
the column driver is configured to determine a voltage level of the second data line during the first time period based on the discard data, and
the source selection multiplexer is configured to determine a logic level of the PWM signal during the first time period based on the voltage level of the second data line.

19. A display pixel comprising:
an in-pixel memory comprising a shift register and an independent bit cell;
a source selection multiplexer configured to generate a pulse width modulation (PWM) signal based on a first output signal from the shift register and a second output signal from the independent bit cell; and
a light emission circuit configured to perform a first light emission operation based on the PWM signal during a first time period at which the in-pixel memory performs a data writing operation.

20. The display pixel of claim 19, wherein:
the light emission circuit is further configured to perform a second light emission operation based on the PWM signal during a second time period after the first time period,
the PWM signal includes a plurality of bit emission periods respectively corresponding to different pixel driving bits, and
a sum of a first number of bit emission periods corresponding to the first time period among the plurality of bit emission periods, and a second number of bit emission periods corresponding to the second time period among the plurality of bit emission periods, is greater than a capacity of the in-pixel memory.
